(19) United States
(12) Patent Application Publication
(10) Pub. No.: US 2026/0269928 A1
(43) Pub. Date: Sep. 10, 2026

(54) MESSAGE FORWARDING USING FLEXIBLE RELAY NODES

(71) Applicant: Fraunhofer-Gesellschaft zur Foerderung der angewandten Forschung e.V., Muenchen (DE)

(72) Inventors: Paul Simon Holt Leather, Berlin-Schlachtensee (DE); Thomas Haustein, Berlin (DE); Lars Thiele, Berlin (DE); Thomas Heyn, Erlangen (DE); Stefan Lipp, Erlangen (DE); Frank Burkhardt, Erlangen (DE); Julian Popp, Erlangen (DE)

(21) Appl. No.: 19/535,272

(22) Filed: Feb. 10, 2026

Related U.S. Application Data
(63) Continuation of application No. PCT/EP2024/072649, filed on Aug. 9, 2024.

(30) Foreign Application Priority Data
Aug. 10, 2023 (EP) 23190921.9

(51) Int. Cl. H04B 7/155

(52) U.S. Cl. CPC H04B 7/15557

(57) ABSTRACT

A relay device is configured for relaying a wireless receive signal as a wireless transmit signal. The relay device is configured for a plurality of relay modes; and is adapted for changing an operation of the relay device to at least one of the plurality of relay modes responsive to a control signal.

### CROSS-REFERENCE TO RELATED APPLICATIONS

This application is a continuation of copending International Application No. PCT/EP2024/072649, filed Aug. 9, 2024, which is incorporated herein by reference in its entirety, and additionally claims priority from European Application No. 23190921.9, filed Aug. 10, 2023, which is also incorporated herein by reference in its entirety.

### TECHNICAL FIELD

Embodiments of the present application relate to the field of wireless communication, and more specifically, to relaying signals by use of relays adapted for changing their mode of operation according to a control signal. Embodiments further relate to recognising a relay in a wireless communication network and to selecting routes through the wireless communication network used for signal relaying.

### BACKGROUND OF THE INVENTION

FIG. 1 is a schematic representation of an example of a terrestrial wireless network 100 including, as is shown in FIG. 1A, a core network 102 and one or more radio access networks RAN₁, RAN₂, . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The term base station (also basestation), BS, refers to a gNB in 5G networks, an eNB in UMTS/LTE/LTE-A/LTE-A Pro, or just a BS in other mobile communication standards. A user may be a stationary device or a mobile device.

The network 100 may comprise one or more transmission reception points, TRPs. A TRP may but is not required to form an individual node of the network. For example, a base station may comprise one or a plurality of TRPs. For example, different TRPs of a base station may serve UEs in different areas or sectors of a cell operated by the base station, just to name a specific example.

The wireless communication system may also be accessed by mobile or stationary IoT devices which connect to a base station or to a user. The mobile devices or the IoT devices may include physical devices, ground-based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an example of five cells, however, the RANₙ may include more or fewer such cells, and RANₙ may also include only one base station. FIG. 1B shows two users UE₁ and UE₂, also referred to as user equipment, UE, that are in cell 106₂ and that are served by base station gNB2. Another user UE₃ is shown in cell 106₄ which is served by base station gNB4. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1B shows two IoT devices 110₁ and 110₂ in cell 106₄, which may be stationary or mobile devices. The IoT device 110₁ accesses the wireless communication system via the base station gNB4 to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1B by the arrows pointing to “core”. The core network 102 may be connected to one or more external networks. Furthermore, some or all of the respective base stations gNB₁ to gNB₅ may connected, e.g., via the S1 or X2 interface or the XN interface in NR, with each other via respective backhaul links 116₁ to 116₅, which are schematically represented in FIG. 1B by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI), respectively. For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTIs) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the terrestrial wireless networks describe above, non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station cannot provide sidelink resource allocation configuration or assistance for the UEs, and/or
may be connected to the base station that cannot support NR V2X services, e.g., GSM, UMTS, LTE base stations.

When considering two UEs directly communicating with each other over the sidelink, e.g., using the PC5 interface, one of the UEs may also be connected with a BS, and can thus relay information from the BS to the other UE via the sidelink interface. Such relaying can be performed in the same frequency band (in-band-relay) or another frequency band (out-of-band relay) can be used. In the first case, communication on the Uu and on the sidelink may be decoupled using different time slots as in time division duplex, TDD, systems.

FIG. 2A is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signalling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 2B is a schematic representation of an out-of-coverage scenario in which the UEs directly communicating with each other are either not connected to a base station, although they can be physically within a cell of a wireless communication network, or some or all of the UEs directly communicating with each other are communicating with/connected to a base station but the base station does not provide for the SL resource allocation configuration or assistance. Three vehicles 206, 208 and 210 are shown directly communicating with each other over a 10 sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2B which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2A, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 3 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 4 is a schematic representation of a scenario in which two UEs directly communicating with each other, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

A scenario described herein may not only comprise nodes like base stations, UEs, IoT devices, but also transmission reception points, TRPs.

In a wireless communication system by way of non-limiting example such as described above, the relaying of messages in application scenarios prior to the invention being made was limited in range or coverage while at the application level, stringent requirements regarding QoS, latency, data rate and so on are to be met.

To increase a range along which a signal may be transmitted in a wireless communication network, relays may be used.

Known forms of relay communication include but not limited to:
Amplify and forward relays (repeater) (A&F);
Band switched amplify, and forward relays (bsA&F);
Decode and forward relays (D&F);
Digitize, amplify, and forward repeaters with and without decoding capabilities (dA&F); and
Decode, store and forward on demand relays (DS&F).

All these technical relaying concepts have specific features in common and/or have a distinct feature, and are usually deployed in wireless networks as network enhancements configured and controlled by network infrastructure. Such known solution is found to provide for insufficient by the inventor as providing only limited advantage.

There is, thus, a need to improve wireless communications.

It is noted that the information in the above section is only for enhancing the understanding of the background of the invention and therefore it may contain information that does not form conventional technology and is not yet known to a person of ordinary skill in the art.

### SUMMARY

An embodiment may have a relay device configured for relaying a wireless receive signal as a wireless transmit signal; wherein the relay device is configured for a plurality of relay modes; and is adapted for changing an operation of the relay device to at least one of the plurality of relay modes responsive to a control signal.

### BRIEF DESCRIPTION OF THE DRAWINGS

Embodiments of the present invention are described herein making reference to the appended drawings, in which:

FIG. 1A shows a schematic representation of an example of a wireless communication system;

FIG. 1B shows schematic representation of an example of a radio access network that may include one or more base stations;

FIG. 2A is a schematic representation of an in-coverage scenario in which UEs directly communicating with each other are connected to a base station;

FIG. 2B is a schematic representation of an out-of-coverage scenario in which UEs directly communicating with each other receive no SL resource allocation configuration or assistance from a base station;

FIG. 3 is a schematic representation of a partial out-of-coverage scenario in which some of the UEs directly communicating with each other receive no SL resource allocation configuration or assistance from a base station;

FIG. 4 is a schematic representation of an in-coverage scenario in which UEs directly communicating with each other are connected to different base stations;

FIG. 5 is a schematic representation of a wireless communication system comprising a transceiver, like a base station or a relay, and a plurality of communication devices, like UEs, according to an embodiment;

FIG. 6 shows a schematic block diagram of a relay device according to an embodiment;

FIGS. 7A-E show configurations of devices in accordance with embodiments, having a single antenna being used for a reception and a single antenna being use for transmission or a single antenna being used for both reception and transmission through the use of a duplex filter;

FIG. 7F shows a schematic block diagram of a relay device according to an embodiment; having an antenna array;

FIG. 7G shows a schematic block diagram of a relay device according to an embodiment comprising a signal processing;

FIG. 8 shows a schematic block diagram of a flexible array in accordance with an embodiment, which may implement some or all of the functionality of relay devices described herein;

FIGS. 9A-H show schematic block diagrams of network topologies according to embodiments;

FIG. 9I shows a summarizing table of the topologies of FIGS. 9A-H;

FIGS. 10A-D show different conceptual representations of a control plane and a user plane connection between a UE and a gNB via relays;

FIGS. 11A-C present a UE-centric point of view in accordance with embodiments described herein;

FIGS. 12A-J show schematic block diagrams of wireless communication networks according to embodiments; and

FIG. 13 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

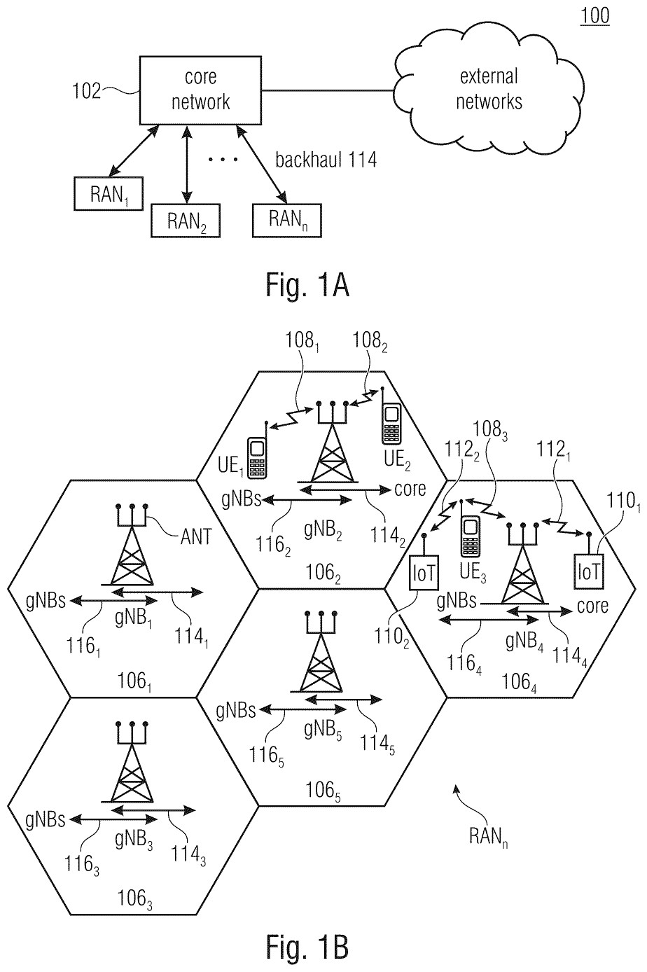

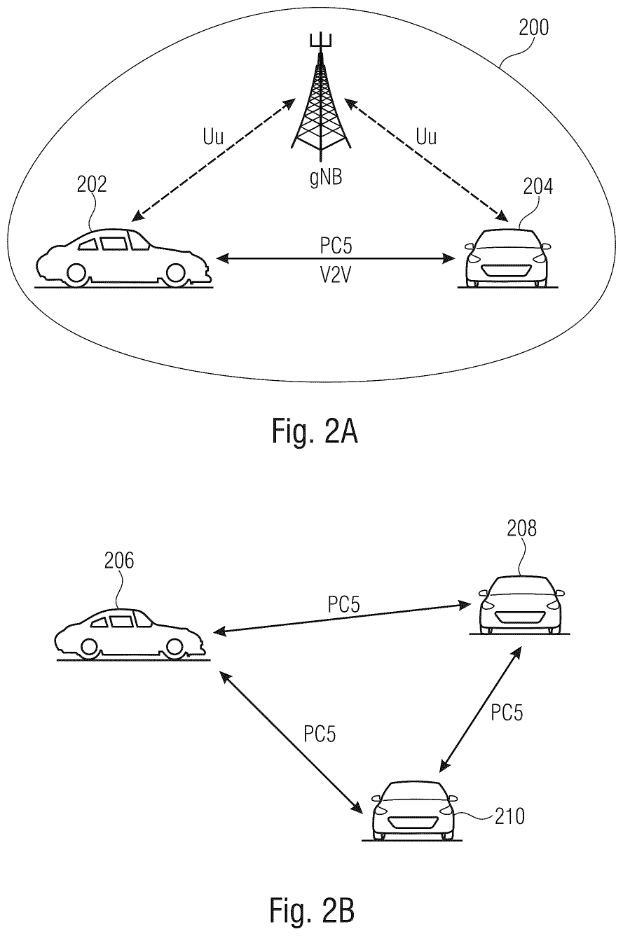

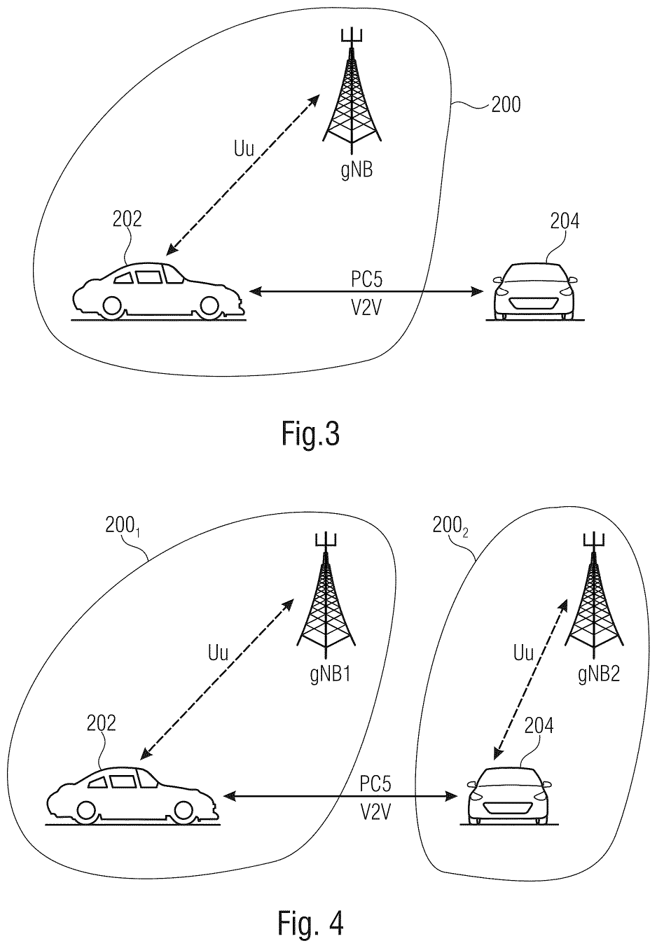

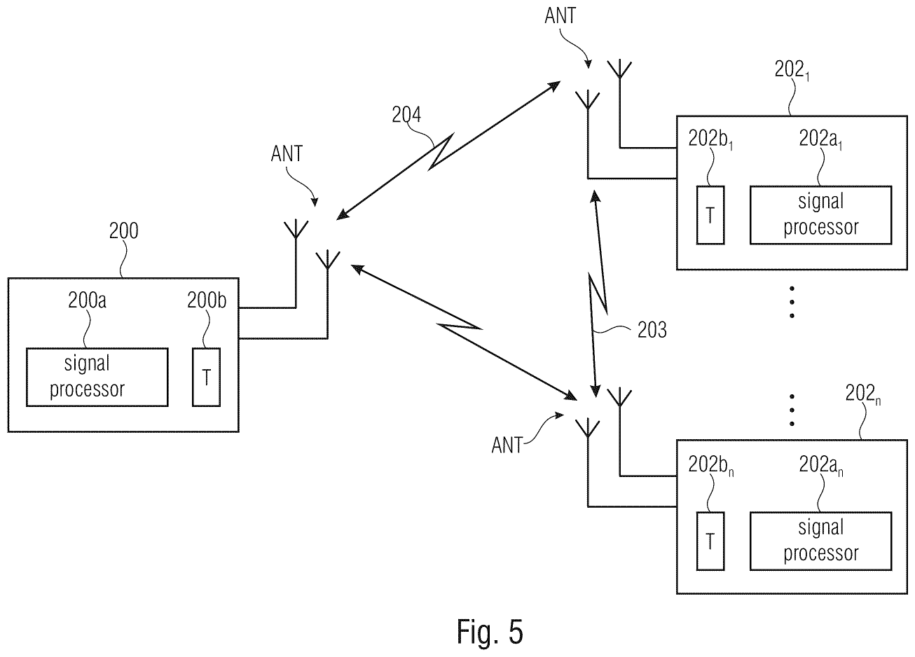

Embodiments of the present invention may be implemented in a wireless communication system or network as depicted in FIGS. 1 to 4 including a transceiver, like a base station, gNB, or relay, and a plurality of communication devices, like user equipment's, UEs. FIG. 5 is a schematic representation of a wireless communication system comprising a transceiver 200, like a base station a transmission reception point, TRP, or a relay, and a plurality of communication devices 202₁ to 202ₙ, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the Uu interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a₁ to 202aₙ, and a transceiver (e.g., receiver and/or transmitter) unit 202b₁ to 202bₙ. The base station 200 and/or the one or more UEs 202 may operate in accordance with the inventive teachings described herein.

The inventors have identified a problem in known relaying strategies that relates to topological and/or deployment immanent deficiencies. Embodiments described herein provide technical means to overcome these by introducing a novel, flexible and effective relaying scheme method.

An overcome topological deficiency can be considered in the following example. A multi-hop relaying string provides wireless connectivity between two ends of a link that otherwise would be out of coverage. However, the end-to-end (E2E) latency requirements and the sensitivity to retransmission delays caused by the standard 5G-NR TDD frame structure and H-ARQ retransmission scheme do not permit multi-hop connections since the 5G-NR design space is constrained to communication links with one hop. To date, latency reduction methods over multiple hops have not been implemented in 3GPP and therefore no solutions have been proposed and standardized.

Currently implemented or standardized solutions in 3GPP focus either on network-controlled repeaters, integrated access and backhaul (IAB) nodes, remote sidelink relays or LTE relays. In common to all of these relay types is: a) that the number of hops shall be limited to one and; b) that the relay scheme (including the one or more relays) is considered to be transparent to the user equipment (UE) at least for IAB, while in sidelink relaying the UEs are aware of the relay and have a sidelink connection to the relay in addition to the E2E.

Thus far, flexible relay configuration—and in particular, that associated with the required performance of a given E2E link—has only been discussed in the context of remote UE relaying in sidelink communication, wherein the relay is configured to relay messages from a UE to the base station if the same (remote) UE cannot communicate with the base station directly or for reliability throughput enhancements.

To frame a problem solved by the embodiments described herein, it is assumed that mission critical messages should be exchanged between at least two nodes, wherein a direct communication between the two nodes is possibly a) not feasible and/or; b) the conditions of the link do not satisfy the requirements of one or more key-performance indicators (KPIs), e.g. data throughput, latency, link reliability, stability, jitter. Other motivation to use a relay for forwarding is, however, not precluded according to the invention.

Furthermore, it is assumed that other nodes are within the communication range of each of the two nodes or in a concatenated multi-hop topology to link the two nodes into a communication chain, thus acting as relays or message forwarders between the two nodes.

Embodiments provide for flexible and configurable combinations of such relay operational modes. Embodiments provide for a relaying device which is adapted on demand to the given application scenario and can be configured to operate in at least one or more of the operational modes listed above or any combination thereof. The configuration and the management of the operational mode can be initiated and/or controlled by the network (gNB), the UE or the relay in a distributed, centralized, hierarchical, assisted and/or autonomous manner. An autonomous control mechanism may include a reporting of suitable relay candidates by one end of the E2E link or intermediaries thus allowing such a candidate to be selected, configured and its operational mode controlled by a designated controlling entity or after a negotiating process between several entities involved in the relaying process and/or benefiting from the relaying process.

Embodiments thereby overcome the inherent limitations in current relaying schemes including but not limited to:
fixed IAB relays and vehicle mounted relays;
layer 3 relays such as Wi-Fi hotspots using smartphones;
sidelink relaying;
network controlled repeaters;
single hop relays specified in 4G-LTE; and
(non)-regenerative relays deployed in space (satellites).

Embodiments provide an end-to-end link-based solution approach, wherein the intended, e.g., determined as optimal, configuration and operation of the relay nodes ensures significant performance improvement of the E2E link.

In the following, several aspects relating to the embodiments are described to specify the concept of a network node with flexible forwarding capabilities (i.e., operational modes). Described herein is a conceptual development of the arrangement of the functional blocks used to create a flexible relay; examples of the organization of such flexible relays within a network topology; and an introduction to the states and timing associated with the discovery, configuration, connection and release of the various network entities. Also the benefits of the embodiments is described.

It is assumed that the network topology providing a background for at least some of the embodiments is of a cellular structure with at least one base station (eNB in 4G LTE, gNB in 5G NR) and at least one mobile terminal (user equipment, UE in 5GNR, “terminal” in ETSI DECT, or “terminal” in IEEE 802.11xx) forming a wireless communication system/network using wireless communication between the base station and the mobile terminal.

Classical relaying in cellular networks is based on the configuration of particular devices as relays. After configuration, these devices can forward messages to a further device in single hop manner.

To allow a more scalable solution, some of the embodiments are directed to include, by the sending device and/or a relay device relaying the message, a header message into data packages/messages to be relayed within the network which contains self-describing instructions and/or parameters allowing suitably-enabled or capable devices in the network to handle and forward such messages in the appropriate manner.

An intelligent relaying method proposed by some embodiments described herein uses a target header to facilitate directed forwarding in a multi-hop network. Knowledge of the intended recipient is beneficial for relay node selection and directional forwarding. Examples of this include the explicit destination per se and the routing table or fields to be used and defined. The method is extendable for multiple hops through the use of tree-type and/or meshed relay network topologies not limited to include hop counters and/or unambiguous packet identifiers which are used to avoid routing loops and/or packet forwarding beyond expiry.

Furthermore, it is assumed that a further node may be introduced to facilitate the forwarding of messages sent into at least one of the bidirectional communication directions (uplink and/or downlink).

The assumed channel duplexing for this invention disclosure is time division duplex (TDD), not excluding frequency division duplex (FDD) or full duplex (FD) channel access for the sharing of downlink/uplink resources.

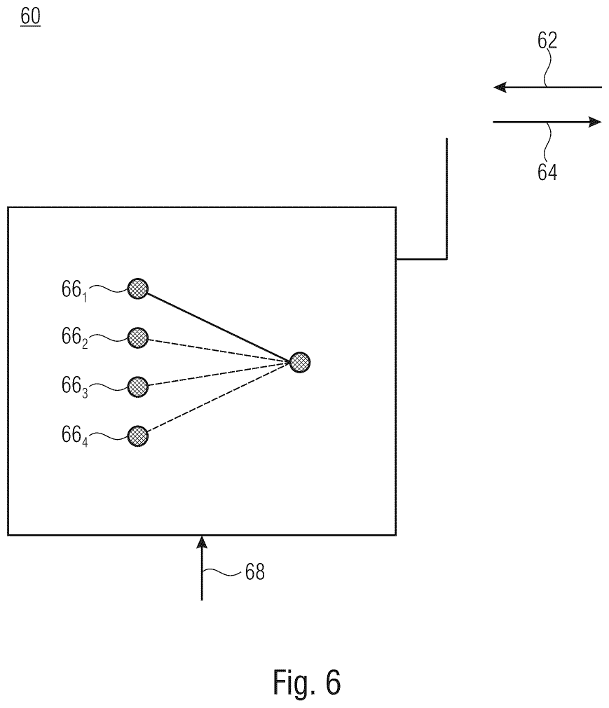

FIG. 6 shows a schematic block diagram of a relay device 60 according to an embodiment. The relay device 60 may be operated in a wireless communication network described herein. The relay device 60 is configured for relaying a wireless receive signal 62 as a wireless transmit signal 64. The relay device 60 is configured for a plurality of at least two relay modes indicated by bullets 661 to 664. The relay device 60 is adapted for changing an operation of the relay device 60 to at least one of the plurality of relay modes responsive to a control signal 68. The control signal 68 may be determined internally, e.g., when internally determining a need to maintain or a change the operation mode. Such an evaluation may be made when evaluating, e.g., capabilities of a node transmitting the wireless receive signal 62 and/or of a node to receive the wireless transmit signal 64. Alternatively or in addition, the relay device may be configured for receiving the control signal from an external device, e.g., a coordinating entity, a node transmitting the wireless receive signal 62 and/or of a node to receive the wireless transmit signal 64. The control signal may be an independent signal but by also be included into a different signal such as the wireless receive signal 62.

The operation modes that the relay device may support may include one or more of the following modes. Embodiments enable comprises a flexible relay in the sense that it is equipped to operate in different operational modes. These modes are not limited to include the following nor any combination thereof:

A&F operational mode: Digitizes signal (ADC) behind Rx antennas followed by receive RF chain, optionally filtering and or precoding (spatial) and forwarding to a transmitter (DAC, Tx-RF chain) and Tx antennas, which are advantageously different (and signal wise sufficiently isolated from Rx antennas) transmitting the received signal again within a short time e.g. the guard interval. This allows forwarding with minimum delay, de facto a slightly delayed version of the original message, advantageously within or a small portion of the guard interval of, e.g. an OFDM symbol used by the communication protocol. Such an operation mode may correspond to a repeater (digital A&F) functionality performed by the network node.

Band switched amplify, and forwarding operational mode (bsA&F): Digitizes signal (ADC) behind Rx antennas followed by receive RF chain, optionally filtering and or precoding (spatial) and forwarding to a transmitter (DAC, Tx-RF chain and Tx antennas operated at a different band of bandwidth part (BWP), and with antennas advantageously different (and signal wise sufficiently isolated from Rx antennas) transmitting the received signal again within a short time e. g., the guard interval. This allows forwarding with minimum delay, de facto a slightly delayed version of the original message, advantageously within or a small portion of the guard interval of, e.g. an OFDM symbol used by the communication protocol and an independent redundancy copy of the same message in another frequency band, this increasing spectral redundancy of the message. This scheme allows the next receiver in the multi-hop chain to process a message from the previous transmitter in the chain and the bsA&F relay in parallel using to independent copies of the same message made available on different frequency resources Such an operation mode may correspond to a repeater (digital band switched A&F) functionality performed by the network node. It is to be noted that a band switch may relate to change a frequency range or frequency band, e.g., within a same radio access technology, RAN such as using an RF signal. According to an embodiment, the band may also be switched to change the properties of the signal, e.g., to use a combination of an optical signal and an RF signal for the combination of signals 62 and 64.

Digitise and Forward (D&F) operational mode: Digitizes signal (ADC) behind Rx antennas followed by receive RF chain, optionally filtering, decoding, storing/buffering and/or precoding (spatial) and selectively or in full forwarding the message to a transmitter (DAC, Tx-RF chain and Tx antennas). Tx antennas can be the same or different as receive antennas. The transmission of the message is delayed until time instances (slots) which are defined to be used for the opposite communication direction, in U slots if the message was receive during D slots. This allows forwarding with a well-defined delay depending on the chosen D and/or U slots, thus introducing a deterministic delay of a distinct number of slots into the E2E communication chain, due to its relaying structure. Furthermore, the relaying after decoding can include a different encoding and/or mapping on physical resources in the WCS. Such an operation mode may correspond to a classical decode and forward (C&F) functionality performed by the network node.

Store and Forward (S&F) operational mode: Digitizes signal (ADC) behind Rx antennas followed by receive RF chain, optionally filtering, decoding, storing/buffering and/or precoding (spatial) and selectively or in full forwarding the message to a transmitter (DAC, Tx-RF chain and Tx antennas). Tx antennas can be the same or different as receive antennas. The transmission of the message is delayed to later time instances (slots) and only executed on demand and triggered by a kind of H-ARQ command, requesting a retransmission in case the next receiver in the multi-hop chain was unable to successfully decode the message which was either received by the transmitter before the relay, by the relay itself of as a combination of messages of the two transmitters. Such retransmission from half-way nodes in a multi-hop system allow faster provision of retransmissions and avoid H-ARQ requests to go back to the original source as it happens with higher layer mechanisms like TCP. This allows provision of retransmission of undetected messages with a well-defined delay depending on the chosen D and/or U slots, thus introducing a deterministic delay of a distinct number of slots into the end-to-end (E2E) communication chain, due to its relaying structure Such an operation mode may correspond to a retransmissions using triggered store and forward relay functionality performed by the network node. Such retransmission schemes can exploit feedback information regarding specific redundancy versions being requested. Examples of redundancy versions include but are not limited to:
Incremental redundancy (extra parity bits transmitted);
Bits mapped to specific layers, e.g. MIMO are requested for one or a few of the layers;
Repetition coding with chase combining;
Redundancy provision distributed across multiple relays (each relay is sending different or same parts of the retransmission message, encoding can be the same of different, furthermore, the encoding can be coordinated, e.g. like in network coding);
UE-2-UE communication or UE-2-gNB communication wherein some UEs operate at least partially as relays; and
Transmit/receive in different frequency bands e.g. FR1 and FR2 over multiple relays, i.e. multi-band combining.

Monitoring operational mode: Digitizes signals and monitors and logs KPIs, events related to links to neighbouring nodes and or a further node one or more hops away. Log files can be reported automatically or on demand. The purpose of this mode is to determine, for example, link quality or degradation patterns, that allow further optimization of the partial links and/or the overall E2E link. These could include mechanisms such as MDR but in distributed and self-organized way and time stamped. Such a mode may be provided or executed by the relay device in combination with a relay mode, e.g., to internally determine the control signal 68 and/or to provide information to other nodes as a basis for decisions made there.

Combinations of the different relaying mode described herein may be applied to provide a flexible and efficient solution for improved E2E wireless communication using multi-hop techniques exploiting the different relaying functionalities of the relaying node by adaptively and flexibly configuring such combinations by either end of the E2E link (UE or gNB) or by one of the relaying nodes in between.

For example, a network node may receive a signal from a transmitting node in a first mode of a TDD slot structure, e.g. DDDDFUUUDD (D: Downlink slot, F: Flexible slot, U: Uplink slot) and may transmit in a different second mode of a TDD slot structure.

As an alternative or in combination, the combination of several relaying modes may facilitate an adaptation of multi-hop communication links with even or odd numbers of nodes to shorter E2E latencies, e.g. round-trip times (RTT) even under TDD constraints which is the most common access scheme in 5G-NR while 4G-LTE was predominately deployed with FDD as Duplexing scheme. Such operation may allow to forward or relay a signal in the wireless communication network along a plurality of hops by use of more than a single relay mode, e.g., based on relay devices operating differently.

According to an embodiment, the relay device 60 may operate, as relay modes, at least a subset of:
an amplify and forward mode;
a band switch amplify and forward mode, including a change of signal type such as optical and RF;
a decode and forward mode;
a store and forward mode.

The relay device 60 may be adapted to operate in a wireless communication network; and may be configured for receiving the wireless receive signal from a user equipment of the wireless communication network; and/or for transmitting the wireless transmit signal to a user equipment of the wireless communication network. However, the relay may also transmit the signal to a further relay or receive signals from a further relay. In combination with the capability of the relay modes descried herein, the relay device 60 may be configured, at least in some modes, to operate as a splitter to divide a set of at least one wireless receive signal into a set of wireless transmit signals, the number of transmit signals being larger than the number in the set of wireless receive signals. Alternatively or in addition, the relay device 60 may operate as a combiner to combine a set of at least two wireless receive signals into a set of wireless transmit signals, the number of transmit signals being lower than the number in the set of wireless receive signals. When combining both modes, the number of signals may also stay same.

Embodiments refer to a conceptual and graphical development of the functional blocks used to implement a flexible relay together with an example on how they can be arranged.

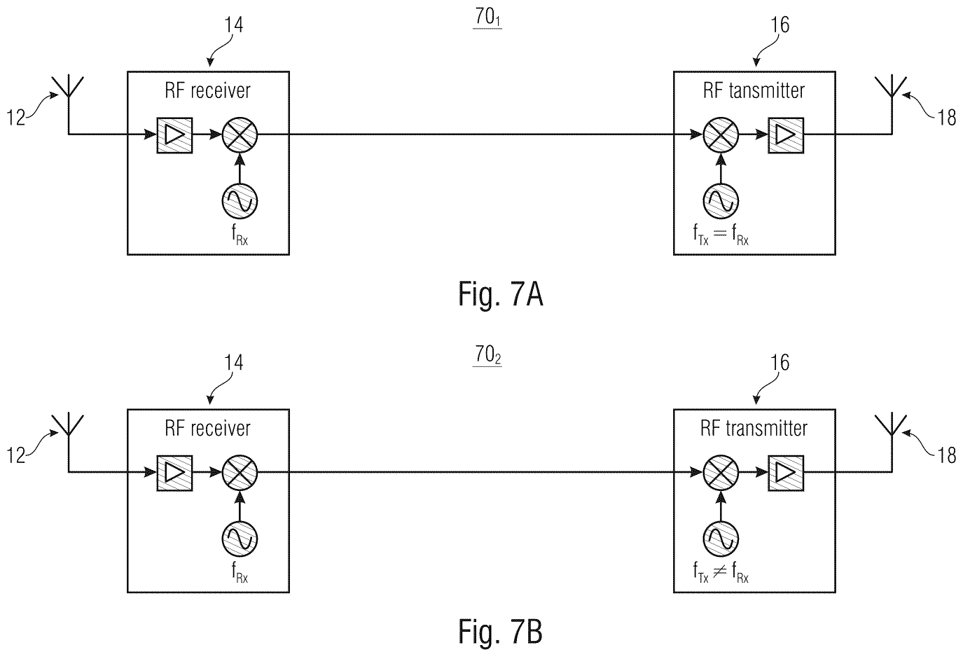

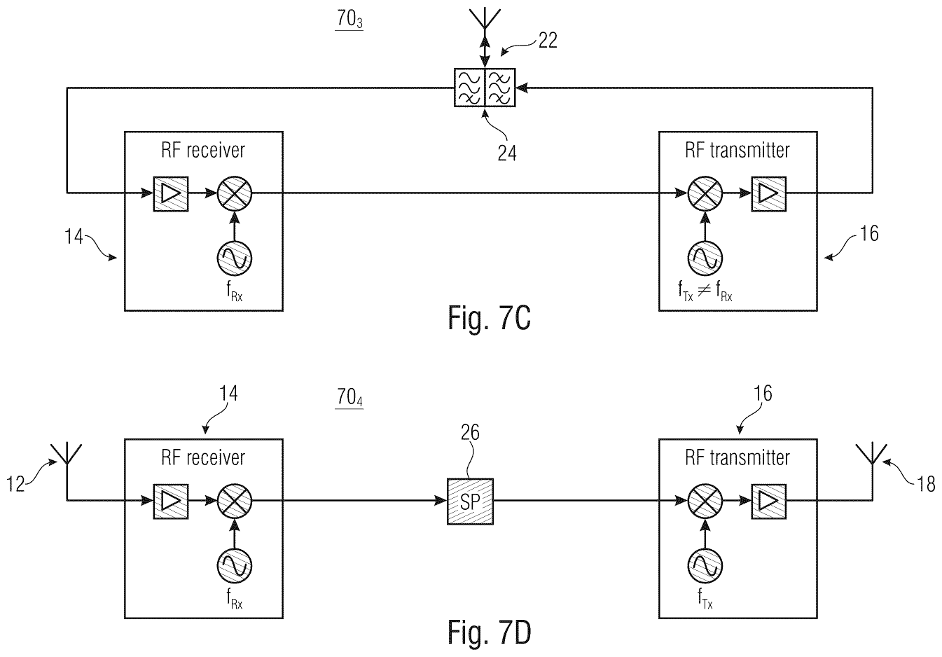

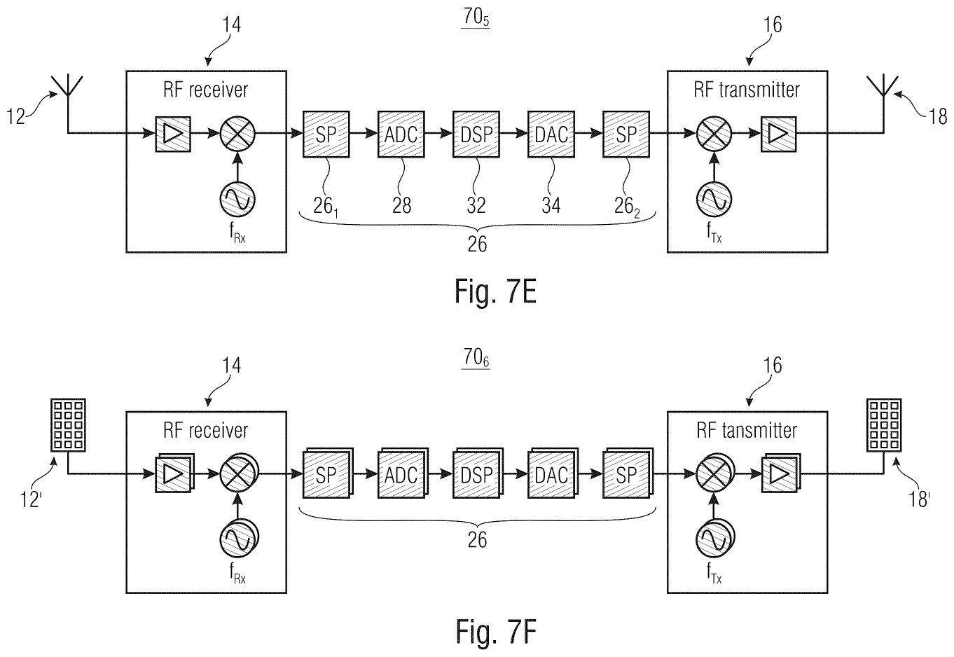

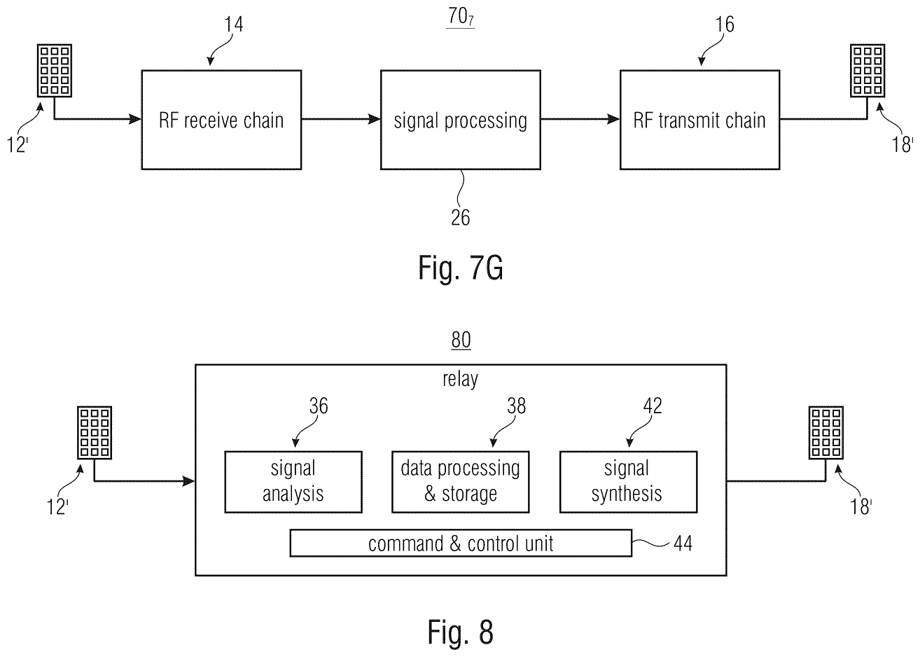

FIG. 7A shows a schematic block diagram of a relay device 701 to illustrate the conceptual arrangement of a receiving antenna 12 followed by an RF receiver 14 which is directly or indirectly connected to an RF transmitter 16 followed by a transmitting antenna 18. The RF receiver 14 and the RF transmitter 16 may operate in a same frequency band, e.g., f_{TX}=f_{RX}, and each uses a separate antenna 12, 18 respectively.

In practice, a self-interference shared by the transmitter 16 and which is passed to the receiver 14 can be reduced by careful arrangement of the antennas 12 and 18. For example, spacing them apart and/or arranging them so that the peaks of their radiation patterns are not overlapping significantly, e.g., their beams point into different directions. FIG. 7A illustrates the concept of an amplify and forward relay 70₁ in which the received signal is amplified and forwarded.

FIG. 7B shows a schematic block diagram of a relay device 70₂, an operation thereof being implementable in the relay device 60 as is the functionality of the relay device 70₁. When compared to the relay device 70₁, the RF receiver 14 and the RF transmitter 16 may operate in different frequency bands, i.e., f_{TX}≠f_{RX}.

FIG. 7C shows a schematic block diagram of a relay device 70₃, an operation thereof may be implemented in the relay device 60. The relay device 70₃ may use a common or shared antenna 22 connected to the receiver 14 and the transmitter 16 via a duplex filter 24. Signal isolation between the frequency ranges used for reception and transmission may be dependent on the duplex distance between these ranges and the filter characteristics of the duplexer.

FIG. 7D shows a schematic block diagram of a relay device 70₄ that may be implemented as operation mode in the relay device 60. When compared to FIGS. 7A-C that have shown for reasons of simplifications a direct connection from the output of the RF receiver 14 to the input of the RF transmitter 16, in practice, it may be more realistic to place a signal processing stage 26 between the receiver 14 and the transmitter 16. The signal processing 26 is shown in FIG. 7D that introduces the concept of a signal processing (SP) block being placed between the output of the RF receiver 14 and the input of the RF transmitter 16. In general, the SP block 26 may be used to represent any form of signal processing, analogue, digital or combinations thereof.

FIG. 7E shows a schematic block diagram of a relay device 70₅, a functionality thereof forming a possible relay mode of the relay device 60. The relay device 70₅ comprises a combination of inter-RF stages comprised of a first stage of signal processing 26₁, e.g., in an analogue way, a digitizer 28, an analogue-to-digital-conversion, ADC, a digital signal processing, DSP, block 32, a signal reconstructor in the form of a digital-to-analogue converter, DAC 34 followed by a second stage of analogue signal processing 26₂. The DSP 32 functions are not limited to include re-synchronization, re-mapping of resource elements, re-modulation of signals, re-interleaving of symbols, re-coding of data, re-direction of packets, data storage, data retrieval and/or data estimation.

FIGS. 7A-7E show a single antenna being used for a reception and a single antenna being use for transmission or a single antenna being used for both reception and transmission through the use of a duplex filter. It is also a possible implementation in accordance with embodiments to provide for a relay comprised of one or more directional antennas which are also directable through the use of mechanical and/or electronic means, for example, using at least one array of antenna elements together with at least one beam forming device. A concept of such a device is shown in FIG. 7F illustrating a block diagram of a relay device 70₆, a functionality thereof being implementable in the relay device 60. A receive antenna 12′ of the relay device 70₆ may comprise an antenna array. Alternatively or in addition, the relay device 70₆ may comprise a transmit antenna 18′ comprising a transmit antenna array. The signal processing 26 may be adapted to operate the multiple antennas of each of the antenna array 12′ and the antenna array 18′.

FIG. 7G shows a schematic block diagram of a relay device 70₇ representing at least the relay devices 70₄ to 70₆. The relay device 70₇ may comprise a receive antenna 12′ and a transmit antenna array 18′ being connected to RF receive chains of the receiver 14, RF transmit chains of the transmitter 16 respectively which may be connected to each other via signal processing 26.

FIG. 8 shows a schematic block diagram of a flexible array 80 in accordance with an embodiment, which may implement some or all of the functionality of the relay devices 60 and 70₁ to 70₇.

The relay device 80 may comprise the receive antenna array 12′ and/or the transmit antenna array 18′, wherein a combined implementation as described in connection with FIG. 7C is not precluded. The relay device 80 may comprise units or functions for signal analysis 36, data processing and/or data storage 38 and signal synthesis 42. These units may be responsive to instructions, commands and/or requests passed to them from a command and control unit 44 of the relay device 80 that may process or even generate a control signal such as control signal 68. The command and control unit 44 may operate autonomously, i.e., it may make decisions based on criteria and/or observations, sequentially, i.e., it may perform certain actions in a certain order, it may operate functionally, i.e., it may form outputs based on inputs, it may operate adaptively, i.e., it may adjust a setting according to observations, it may operate programmatically, i.e., it may receive commands, requests or instructions from another network entity such as a UE, a gNB or from other relays, and any full or partial combinations thereof.

In view of this, embodiments provide for a relay device that may be configured for receiving a control signal indicating a relay mode or a combination of relay modes; and for operating according to the control signal.

A relay device according to an embodiment may comprise an antenna unit configured for beamforming; wherein the relay device is adapted to receive and/or transmit wireless signals using a beamforming technique and using the antenna unit.

A relay device according to an embodiment may comprise an antenna unit and an actuator; wherein the actuator is configured for changing an orientation of the antenna unit to change a direction and/or polarisation of a signal received or transmitted with the antenna unit with reference to a further device.

A relay device according to an embodiment may comprise a control unit or command and control unit 44; configured for controlling an operation of the relay device.

A relay device according to an embodiment may be adapted that the control unit is configured for controlling the relay device:
autonomously;
sequentially;
adaptively;
programmatically; and
any full or partial combinations thereof.

A relay device according to an embodiment may be implemented as a UE, a gNB, an RU, a DU, a CU, an IAB-node such as an IAB-DU or an IAB-MT), a repeater, a relay-node, a RIS or any other node or device which supports reception and transmission of wireless signals.

A relay device according to an embodiment may be configured for receiving a request for relaying a signal from a first device such as a user equipment, UE, or another relay device to a second device such as a basestation or another relay device; wherein the relay device is configured to negotiate a parameter of a first connection between the relay device and the first device with the first device; and/or configured to negotiate a parameter of a second connection between the relay device and the second device with the second device to establish at least a part of a relayed connection between the first device and the second device.

A relay device according to an embodiment may be configured for receiving a connection information from the wireless communication network, e.g., a deciding entity thereof, the connection information indicating a parameter of a connection of the relay device to another device; wherein the relay device is configured for controlling the connection based on the connection information. That is, the relay is possibly not directly connected to the gNB, e.g. another relay could be in-between. The same is true for the relay to be at least one further hop away from the UE.

A relay device according to an embodiment may be configured for providing, to the wireless communication network, at least one of an input, a parameter, a report and a feedback message to provide information to a deciding entity of the wireless communication network for a decision about a parameter of a connection of the relay device.

A relay device according to an embodiment may be configured for signalling to the wireless communication network a configurability information indicating that the relay device will operate according to a connection information received from the wireless communication network that indicates a requested parameter of a connection of the relay device; and/or indicating that the relay device will forward connection information to a device indicated in the connection information.

In the following, some examples of relay-equip network topology concepts are explained. To begin with, attention is drawn to the controlled plane, CP, and user plane, UP, functions of the wireless communication link wherefore it should be noted that UP and CP can at least one of using different RF chains, employing different antenna beams or antenna ports and/or operating in different frequency ranges. For example, CP can be communication via FR1 while UP can be transferred over FR2. This does not exclude both CP and UP being conveyed in the same frequency range nor in the same combination of frequency ranges.

Similarly, the CP and UP can be assigned to FDD and/or TDD operation and combinations thereof. Likewise, the different planes can be transferred using different and/or similar waveforms, numerologies, resource element assignments, modulation and coding schemes, e.g., in view of data rates, spatial layers, polarizations, scheduling and the like.

The mode of operation of the relay may be configured or pre-configured and/or adapted for the same mode or for a different mode when relaying CP or UP.

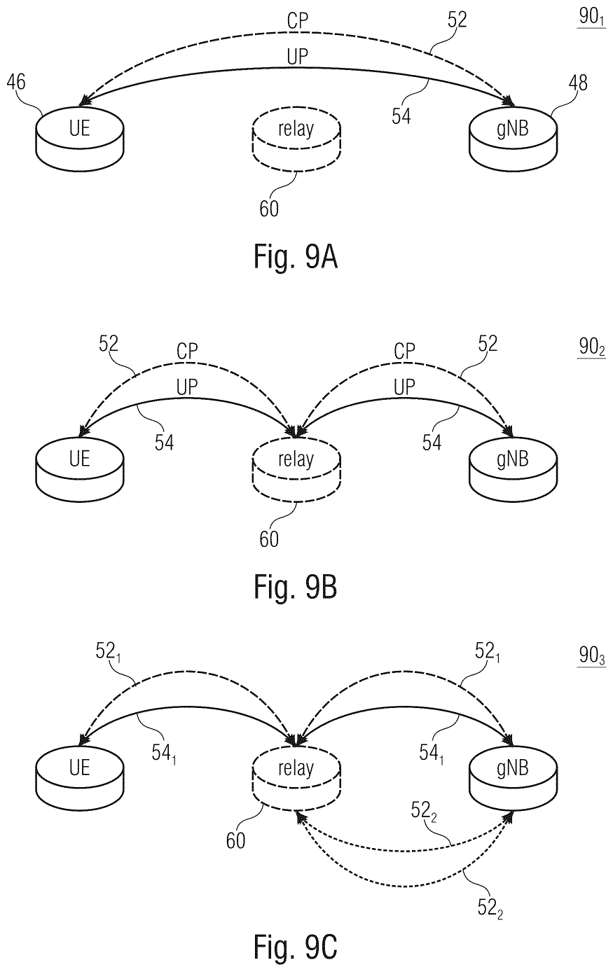

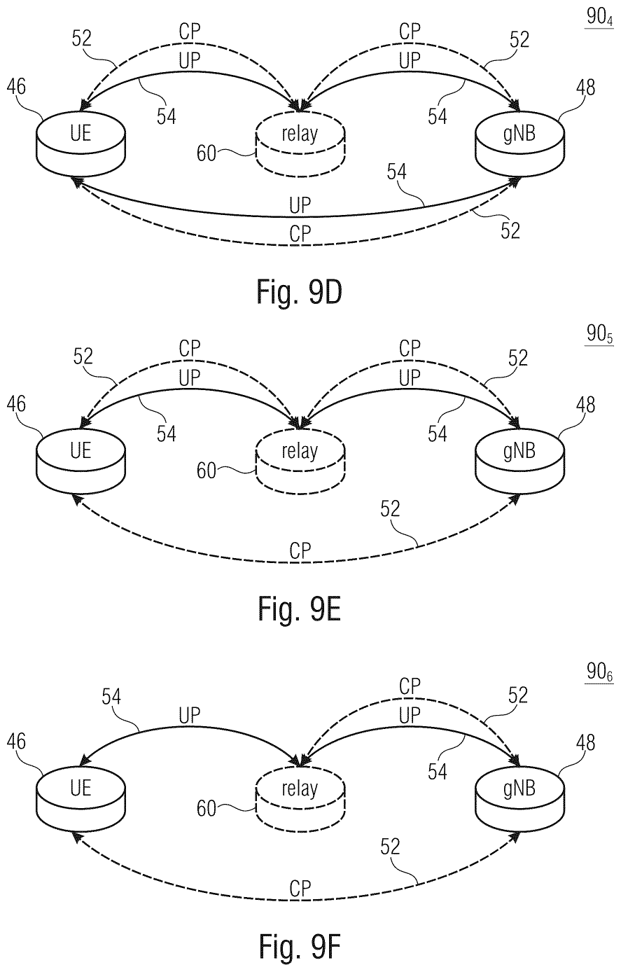

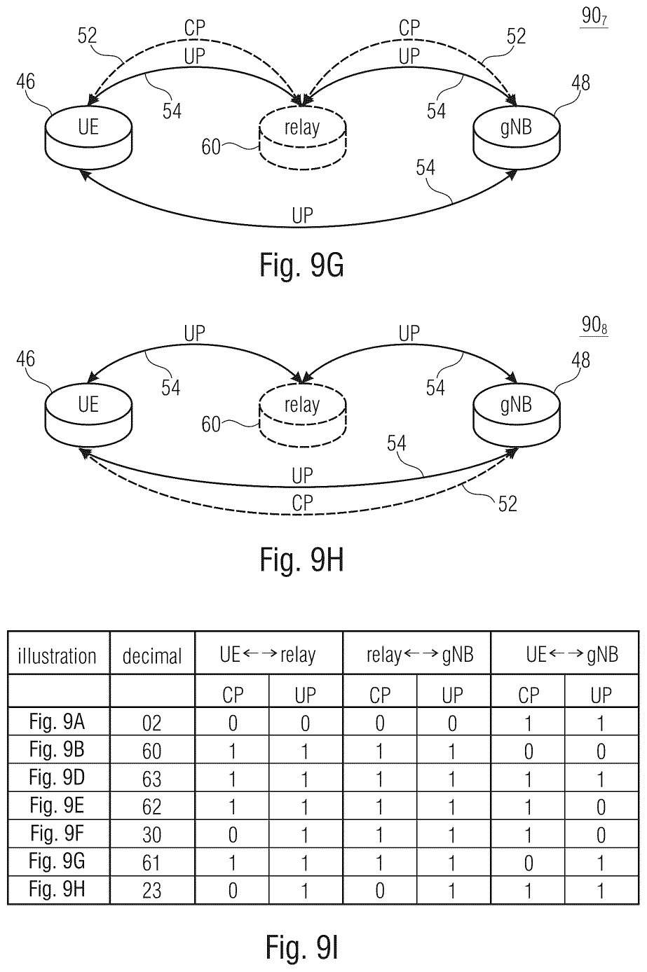

FIG. 9A shows a schematic block diagram of a network topology 90₁ according to an embodiment in which a UE 46 and a base station, gNB 48, e.g., a UE and a gNB of network 100, are directly connected to allow a connection of CP 52 and UP 54 without using relay device 60 which can also be relay device 80.

FIG. 9B shows a schematic block diagram of a network topology 90₂ according to an embodiment in which the connection of CP 52 and UP 54 between the UE 46 and the gNB 48 is provided via the relay device 60.

FIG. 9C shows a schematic block diagram of a network topology 90₃ according to an embodiment in which a duality of the CP and UP is highlighted. A first CP 521 is used for gNB control of the UE 46 and a second CP 52₂ is used for gNB control of the relay device 60. A first UP 54₁ is used for the transfer of data between the UE 46 and the gNB 48 and a second UP 54₂ is used for the transfer of data between the gNB 48 and the relay 60. Although not shown in each figure, such a split may be provided in other embodiments described herein.

FIG. 9D shows a schematic block diagram of a network topology 90₄ according to an embodiment where the control plane 52 and the user plane 54 connection between the UE 46 and the gNB 48 is enabled directly and via the relay device 60.

FIG. 9E shows a schematic block diagram of a network topology 90₅ according to an embodiment where the control plane 52 and the user plane 45 connections between the UE 46 and the gNB 48 are provided both directly and via a relay in which however there is no direct UP connection between the UE 46 and the gNB 48.

FIG. 9F shows a schematic block diagram of a network topology according to an embodiment where the CP connection between the gNB 48 and the UE 46 and between the gNB 48 and the relay device 60 is provided. The UP connection from the gNB 48 to the UE 46 is made via the relay device 60.

FIG. 9G shows a schematic block diagram of a network topology 90₇ according to an embodiment where the CP and UP connection is between the UE 46 and the gNB 48, both directly and via a relay device 60 in which however there is no direct CP connection between the UE 46 and the gNB 48.

FIG. 9H shows a schematic block diagram of a network typology 90₈ according to an embodiment, where the CP and UP connection between the UE 46 and gNB 48 are both directly and via a relay in which however there is no CP connection via the relay device 60.

FIGS. 9A-H present different scenarios that are summarized in FIG. 9I from which is should be noted that additional connection permutations are possible. The table presented in FIG. 9A uses a binary or Boolean notation to show connections, where a zero/0 represents no connection and a “1” represents a connection, thus allowing a decimal representation of these states.

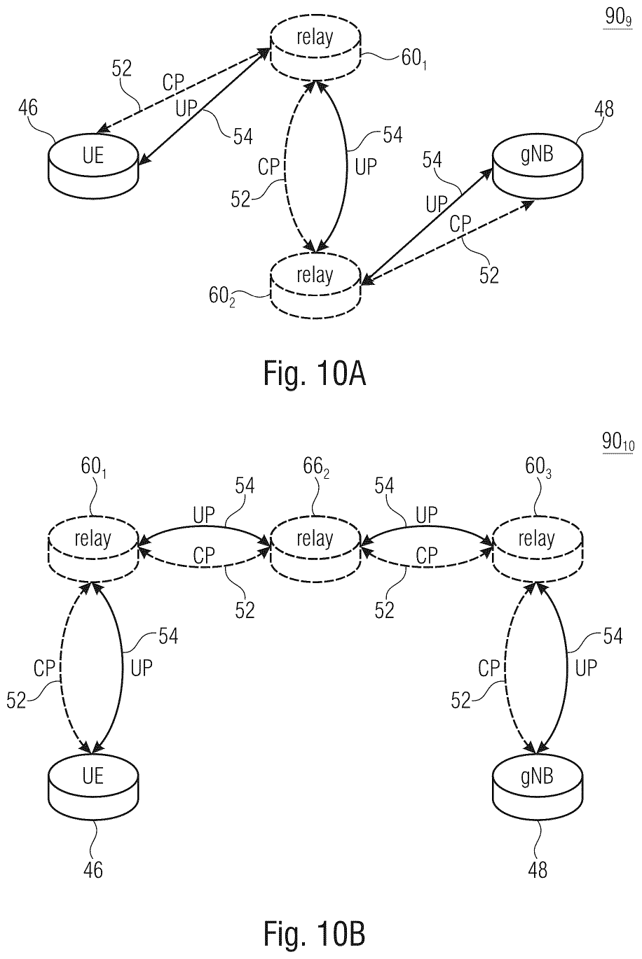

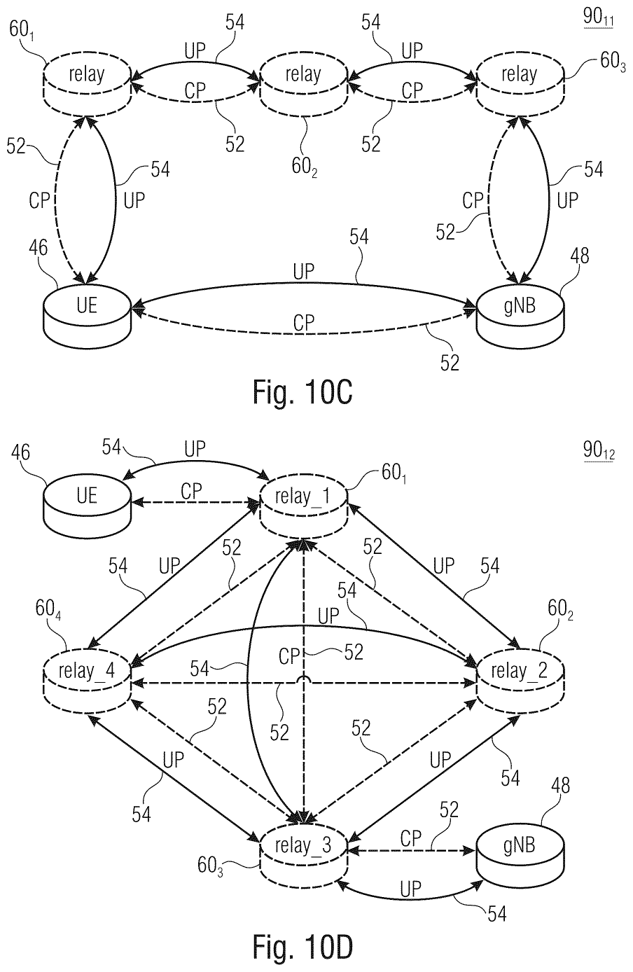

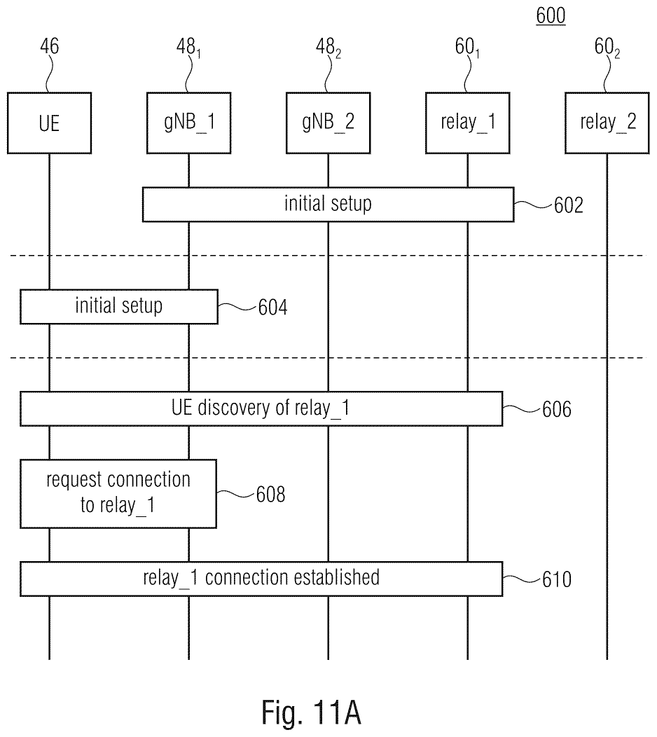

It is to be noted although FIGS. 9A to 9H and therefore FIG. 9I refer to a connection from the UE to a gNB via a relay, the concept of relaying can also be used between UEs operating a sidelink connection and two relays that receive signals from another relay or provide signals to another relay, i.e., to multi-hop relaying. Referring to the multi-hop relaying, FIGS. 10A-C shows schematic block diagrams of network typologies 90₉, 90₁₀ and 90₁₁ according to embodiments without deviating from the interchangeability of the UE 46 and the gNB 48 by other nodes.

In FIG. 10A there is extended the single relay concept to the case of two relays. In FIGS. 10B and 10C, three relays 60₁ to 60₃ are used. Again, it should be noted that the figures do not show all of the possible permutations covered by the embodiments.

According to FIG. 10A, there is provided a conceptual representation of the control plane 52 and the user plane 54 connection between a UE 46 and gNB 48 via two relays.

In FIG. 10B there is shown a conceptual representation of the control plane 52 and the user plane 54 connection between a UE 46 and a gNB 48 via three relays.

In FIG. 10C there is shown a conceptual representation of the control plane 52 and the user plane 54 connection between a UE 46 and gNB 48 both directly and via three relays.

FIG. 10D shows a schematic block diagram of a network typology 90₁₂ according to an embodiment. There is shown a conceptual representation of a control plane 52 and user plane 54 connection between a UE 46 and gNB 48 via a mesh comprised of four relays. All possible routes of inter-relay CP and UP connections are shown, while a direct route between the UE and gNB is not shown, this is not excluded according to embodiments. It should also be noted, that the number of relays and number of UE and number of gNBs is selected for illustrating examples according to the present invention. In FIG. 10D it may be seen that based on the mesh structure of the relay 60₁ to 60₄, there may arise scenarios where one or more relays may operate as a splitter to split one or more signals in a different and in particular higher number of signals and/or as a combiner to combine received signals to a lower number. In combination thereof, signals to be relayed may be re-structured and/or re-generated.

In a mesh network shown in FIG. 10D, the routes used for the connection of data of control plane 52 and data of the user plane 54 to and from the gNB, the UE and the relays may depend on the data being routed.

Embodiments are based on the idea to use a mechanism of proximity services (ProSe) as a means for the UE to discover one or more relays that may be used for signal transmission or reception. Assuming that the relays of the system are using a different frequency so it may forward the relayed information transparently, it becomes possible that multiple relay can cooperate and/or that a relay may receive the same data (CP and/or UP) from different sources, e.g., from tier 1 and also from tier 2.

In connection with embodiments described herein, an identification and/or organization of a use of relays is addressed. Embodiments relate to an identification or recognition of relays as well as the identification of possible routes through a network, such routes may possibly change dynamically.

UE-assisted relay identification and/or relay-assisted UE identification. Embodiments allow to identify, on the UE-side, relay-side and/or gNB-side a recognition of another relay. Embodiments also allow for a relay assisted identification or positioning of UEs to deliver data.

A relay-assisted UE activity identification may relate to an inter-UE CLI report, e.g., to a 3^{rd} party. A digitize-and-store relay can be used to collect information that is collated into the form of a report that is eventually forwarded (on request/schedule/trigger/event/etc.) to basestation.

In the following there are provided details about procedures involved in embodiments and associated signalling to apply the relaying schemes and combinations thereof onto network nodes configured to operate as message relays as described in the problem statement.

To keep the proposed concept and possible implementation options holistic, a network node with relaying functionality can be any node capable of communicating within the framework of the WCS, this includes: UE, gNB, RU, DU, IAB-nodes (IAB-DU, IAB-MT), repeaters, relay-nodes, a reconfigurable intelligent surface, RIS, or any other nodes/devices which support reception and transmission of wireless signals, therefore being equipped with the basic capability of message forwarding (receive and transmit).

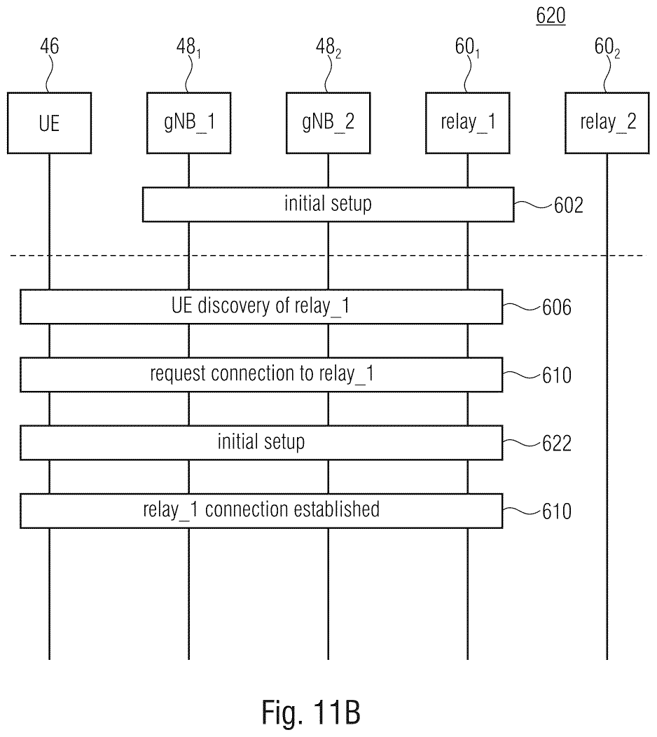

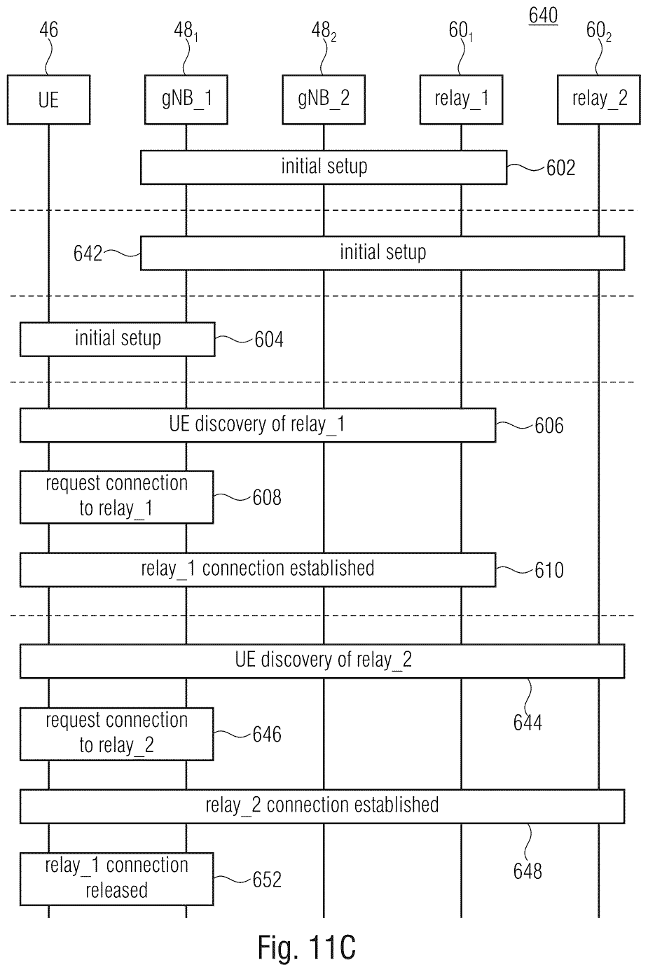

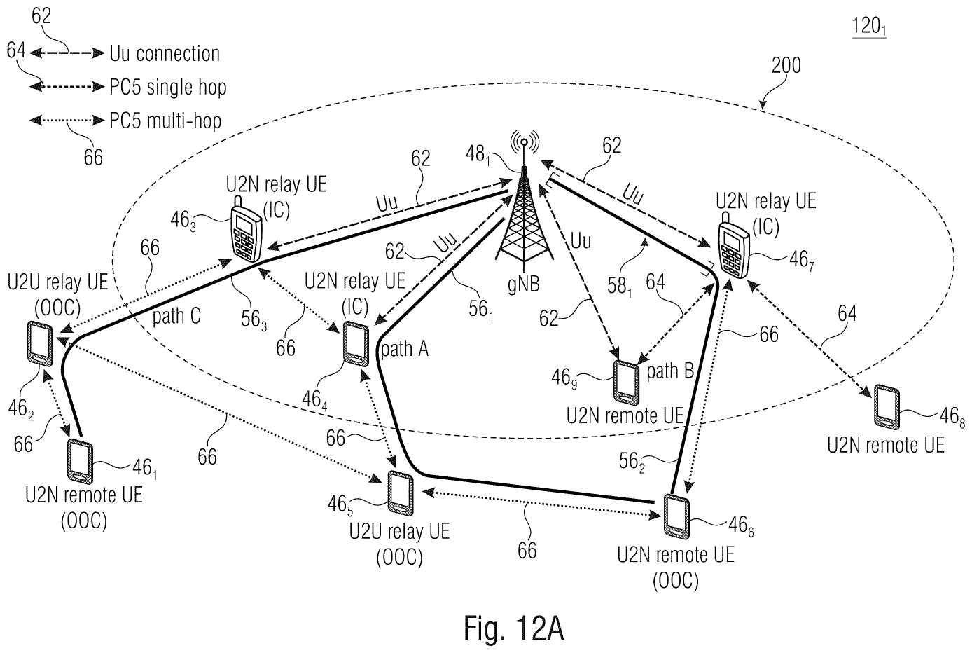

FIGS. 11A-C present a UE-centric point of view in the sense that it is the UE that recognises or “sees” the relay rather than the relay being “transparent” to the UE and thus either makes a request for connection to the relay directly to the relay itself or to the gNB. Alternatively, the relays could themselves discover the presence of UEs.

The following concepts should be noted:
the relay is capable of initiating link brokerage with the gNB and/or the UE
“transparent” in appearance can mean
   Transparent before the relay is used
   Transparent when operating with the UE
   “transparency” is a matter of perspective, seen from
      the UE,
      the gNB, or
      the relay and
      depends when the device is discovered, configured, or connected
   “transparency” can also be limited to a specific protocol layer, e.g. PDCP, or the application layer.

FIG. 11A shows a schematic representation of a state configuration chart 600 showing the connection of a UE such as UE 46 and a first relay such as relay device 60 and/or 80 to a first base station, the UE discovery of the relay 60₁, a request to connect to it and the establishment of a connection. In 602 an initial setup between the gNB 48₁ and the relay 60₁ is provided. In 604 an initial setup between the UE 46 and gNB 48₁ is provided.

606 comprises a UE discovery of relay 60₁ or vice versa. 608 comprises a request connection of UE 46 to relay 60₁ and 610 comprises an established connection between UE 46 and relay 60₁.

FIG. 11C shows a simplified state configuration chart 620 according to an embodiment showing the connection of a first relay 60₁ to a first base station 48₁, the UE discovery of the relay 60₁, a request to connect to it and the establishment of a connection. In 602 an initial setup between the gNB 48 and the relay 60₁ is provided. In 606 a UE discovery of relay 60₁ is provided as described in connection with FIG. 11A. Based thereon a request connection is provided to relay 60₁ in 610. An initial setup 622 is provided between UE 46 and relay 60₁ and in 610 a connection is established between the UE 46 and the relay 60₁. Whilst in FIG. 11A the relay 60₁ and the UE 46 are independently registered with gNB 48₁ as the UE discovers relay 60₁ and determines that it might offer a potential improved link over gNB 48₁ such that it requests to be connected to relay 60₁, in FIG. 11B the relay 60₁ is independently registered with the gNB 48₁ but the UE 46 is not. When the UE 46 discovers relay 601 it requests to be connected to it. As the UE 46 is not yet connected to gNB 48₁, the connection negotiation is made in two legs. One between relay 60₁ and gNB 48₁ and the other between relay 60₁ and the UE 46. FIG. 11C presents a simplified state configuration chart 640 showing the connection of a UE 46 and a first relay 60₁ to a first base station 48₁, the UE discovery of the first relay 60₁, a request to connect to it, the establishment of a connection, the UE discovery of a second relay, a request to connect to it, the establishment of a second connection and the release of the first connection. In 602 an initial setup between gNB 48₁ and relay 60₁ is provided. In 642 an initial setup between gNB 48₁ and relay 60₂ is provided. Further, in 604 an initial setup between UE 46 and gNB 48₁ is provided. In 606 a UE discovery of relay 60₁ is provided and allows for a request of the connection to relay 60₁ in 608. In 610 a connection is established between UE 46 and relay 60₁. In 644, the UE 46 discovers relay 60₂ and in 646 the UE 46 requests a connection to relay 60₂ via gNB 48₁. In 648 the relay 46 establishes a connection to relay 60₂ and in 652 the UE 46 releases the connection to relay 60₁ via signalling with base station 48₁.

Relays 60₁ and 60₂ and the UE 46 are independently registered with gNB 48₁. When the UE 46 discovers relay 60₁ and determines that it might offer a potentially improved link over gNB 48₁, it may request to be connected to relay 60₁. When the UE 46 discovers relay 60₂ and determines that it might offer a potentially improved link over relay 60₁, it may request to be connected to relay 60₂ in addition or as an alternative to the connection provided to relay 60₁.

It is to be noted that relay 60₁ may refer to a first relay or to a first group of relays and that relay 60₂ may refer to a second relay or a second group of relays.

A relay node configuration in accordance with embodiments may include but is not limited to:
A relay mode
   Forwarding delay. This is the time period with which the forwarding of information is delayed. This might be used for:
      Synchronization
      Scheduling
      Interference management
      Network coding e.g. Alamouti coding
   Filtering on/off:
      RF signals
      Baseband signals
      Spatial beamforming
      Selection of antennas, antenna arrays, antenna ports
      Splitting into different MIMO layers
   Frequency conversion. This refers to the transfer of signalling information from one RF band to another RF band—for example, from FR1 to FR2—and within FR1 and FR2—for example from one operating band to another or for the redistribution of component carriers in carrier aggregation or reassignment of bandwidth parts (BWPs). Resampling (both over- and under-sampling). Frequency conversion is also of interest in multiple basestation scenarios that use frequency ranges that not all UEs can support. Here, the relay retransmits information using the appropriate frequency bands for specific UEs.
   k re-transmissions. The relay may be configured to retransmit packets of information (at given times, a given number of times, until an ACK is received).
   Decoding packets and applying different MCS according to the content type. For example, for content that contains time critical information, the relay having recognized this type of content determines that it should be (re-) transmitted in a more reliable manner and thus reduces the MCS (e.g. from 24 to 12).
   Packets and/or data flows may be associated to different traffic classes and priorities
   Amplification
      Closed-loop, such a loop may be controlled via the relay, the gNB and/or the UE
   Multi-operator scenarios for access links and backhaul links
      UE operating in:
         MUSIM single MNO
         MUSIM multiple MNOs.
         Dual connectivity with same or different RAT (NSA, LWA)
      Relay operating backhaul link in:
         MUSIM single MNO
         MUSIM multiple MNOs
         Dual connectivity with same or different RAT (NSA, LWA)
      Based on who owns, installs, operates the relay:
         Includes UE to network relaying (one link is UE-2-UE)
         Touches operation of relay in unlicensed spectrum
         Relay could be deployed in space (NTN) and provided temporarily or location based to support different MNOs as an enhancement service.
         Spectrum used by relay can be different or the same like used by gNBs.
         Relays of different network should be announced to UE by current serving network or a relay information function (RIF), UE can be (pre)-configured about relays in case of Out of Coverage
         Relays could provide a gNB proxy or mimicking function (cell identification broadcast).
         Relay identifies itself to UEs and other relays in access link (gNB) and backhaul link (MT) using cell broadcast
      Handling situations with high number or density of relays, e.g. vehicles mounted relays in traffic jam:
         Broadcast may include routing options via other relays
         Relay may provide information about:
         Neighbouring relays
         Quality of links (data rate, latency, jitter) to the neighbour and beyond (number of hops or end to end to first gNB)
         Routing options to access to the network
         Capabilities and capabilities of neighbours (if available)
         Number of (connected) UEs
         Ad hoc network flag (if relay is not aware of any route towards the network (RAN)

### Relay Node Capabilities and Associated Capability Signalling (Initial Setup)

Relay node capabilities have to be signalled towards the network gNB by the relay when registering to the network. Capabilities to be signalled to the network are e.g. but not limited to
physical layer parameters like frequency ranges, carrier bandwidth, possible transmission parameters,
further capabilities like:
   multi-hop support,
   number of supported hops,
   number of supported simultaneous UEs,
   position, location in a multi-hop route,
   TDD frame structure,
   Supported relay operational modes,
   Multi-path support with either
      1 direct and 1 indirect path or
      1 direct path and 2 or more indirect paths or
      2 or more indirect paths
   An indirect path being
      A non-3GPP path or
      a 3GPP path not based on Sidelink

For future proof use of proposed novel features in relaying the capabilities of the relay should be further matched with capabilities of the UE and the gNB as link pairs and/or a concatenation thereof.

The UE shall signal its relaying capabilities to the network (as extension of the existing UE capability reporting during attachment to the network in 4G and 5G) and/or to the relay. UE relay mode support can be signalled:
Directly from UE to relay or
Indirectly: from UE to gNB, and forwarded by gNB to relay
Direct forward from UE to gNB via relay in a transparent and/or preconfigured relay mode (default relay mode) and then forwarded from gNB to relay and all the way in reciprocal fashion.

Relay node capabilities and associated capability signalling of the UE include but are not limited to:
Relay node capabilities to UE, network and/or other relays (concatenation of relays or meshing)
Supported relaying modes of UE (single hop, multi hop, supported number of connected UEs, . . . ) (currently, SL relaying only supports a single remote UE, but not multiple UEs connected to a relaying UE)
Supported processing time/tolerated latency (because a relay, especially a multi-hop relay introduces latency; e.g. low latency LTE sTTI redefined the required latency of UEs for signal processing)
Supported frequency bands for relaying (similar to UL MIMO, which smartphones do not support in all frequency bands).
From relay to network and/or from relay to UE

According to an embodiment, the relay device is configured for signalling a capability information of the relay device to another device, e.g., a gNB, the capability information comprising:
a physical layer parameter like frequency ranges, carrier bandwidth, possible transmission parameters,
a capability to support multi-hop,
a number of supported hops,
a number of supported simultaneous UEs,
a position or location, e.g., of the relay device in a multi-hop route, e.g., a geolocation, and/or a relative location or distance
an orientation, a polarization, an polarization match, a directivity of receive or transmit beam pattern for the 1^{st} or 2^{nd} link of the relay
an implemented or supported TDD frame structure,
a supported relay mode,
a multi-path support such as
a direct and at least one indirect path to the other device; or
at least two indirect paths to the other device;
wherein an indirect path is a non-3GPP path or a 3GPP path not based on Sidelink;
a path property or path-segment property
a beam ID,
a frequency shift, and
a jitter

Beyond the capability of the relay device such capability could be provided per link of the relay (at least 2 links are needed to make it a relay and not an end point). Therefore, please keep claim language at a level, which allows more than 2 links to be supported by a relay device.

Further to signalling a capability, a relay device may signal an availability of such capability on a per-relay or per-link basis.

According to an embodiment, the relay device is adapted for signalling an availability information of the relay device to another device, e.g., a gNB, the availability information indicating a functionality of the relay device to provide for a capability in the wireless communication network, e.g., after being configured accordingly.

According to an embodiment, the relay device is to signal capability information and/or availability information on a device level, on link-level or on a group-of-link-level.

According to an embodiment, the relay device is to provide for at least one of a combiner of different path segments into a combined path segment; a splitter of a first path segment into at least two path segments; and a mesh into a particular direction of the wireless communication network.

According to an embodiment, the relay device is to provide for a path segment in the wireless communication network that provides for a redundant path or a path diversity for at least one end-to-end link of the wireless communication network.

According to an embodiment, the relay device is receiving a wireless receive signal to be relayed through a unidirectional or a bidirectional path segment; and/or wherein the relay device is transmitting a wireless transmit signal relaying a receive signal through a unidirectional or a bidirectional path segment.

According to an embodiment, the relay device is to operate a path segment based on an associated parameter that relates to at least one of a quality of service, a priority, a redundancy, and a latency of a relayed signal.

### Detection and Signalling of Relays (Discovery)

Detection and signalling of relays available and/or active in an E2E communication path include but are not limited to:

From network side:
Relay candidate discovery, e.g. proximity, location, reception/transmission range, reception conditions (note: forward and backward route can be different)

From UE Side (also for ado relaying without connection between gNB and UE)
Relay candidate discovery, e.g. proximity, location, reception/transmission range, reception conditions (note: forward and backward route can be different)
Detection of pre-configured Relay nodes
Providing Relay with UE communication needs (UE to relay)
   Data rate, QoS
   Latency requirements
UE capabilities (waveform parameters, frequency bands, MIMO capabilities, . . . )

After detection the discovery process starts
Network controlled:
   Reading out the capabilities of relays
   Reading out communication needs of the UE
   Reading out the list of connected relays/devices per Relay
   Calculating communication/relay routes to fulfil communication needs
      Consider cost function
      Relay selection (per communication route).
      Multi-Hop path selection
      Resource assignment (Resource pools, Slot structure, relay role along a multi-hop trace
   Signalling the result to the Relays/UEs
      Per communication route/path.
Ad hoc mode—no configuration by network required or if no connection to the network is needed/possible.
   At least one of the involved nodes/devices (UE or relay) needs to fill the role of a E2E link manager or controller.
   The transition from discovery of relaying candidates to connection establishment might be floating, I.e. some of the steps above could be part of step “connection establishment”

A device in accordance with this aspect is configured for wirelessly communicating in a wireless communication network, e.g., as a user equipment, UE, the device configured for:
recognising a relay device in the wireless communication network and recognising a relay mode of the relay device according to which the relay device relays a wireless receive signal as a wireless transmit signal;
adapting a transmission of a wireless signal as the receive signal according to the relay mode;
or adapting a reception of a wireless signal as the transmit signal according to the relay mode.

According to an embodiment, such the device is configured for:
performing a relay candidate discovery, e.g. based on one or more of a proximity, location, reception/transmission range, reception conditions; detection of a pre-configured relay device or relay capability; and signalling, to the relay device, information indicating a communication need, e.g., UE to relay, the communication need comprising at least one of:
   a need for network access;
   a need for internet access;
   a need for transmission of emergency message;
   a need to establish a communication link to a target device or target address;
   a data rate and/or QoS;
   a latency requirement; and
   a device capability such as a waveform parameter, a frequency band, a MIMO capability.

It is to be noted that the capability may optionally include signals/flags including e.g. positioning anchor, internet access point (now, always, sometimes), message storage/logging, forwarding (immediate, delayed). Such flags may help the UE to make decisions on selecting suitable candidates for establishing a relayed connection.

According to an embodiment the relay capability relates to one or more of a positioning anchor, an internet access point, a time of availability thereof, such as now, always, sometimes, e.g., at specific times, a message storage capability a logging capability, a forwarding capability such as immediate or delayed.

According to an embodiment the device is configured for discovering and/or connecting to the relay device in an Ad hoc mode.

According to an embodiment the device is configured for recognising a first relay device for a first path or a first direction of a first wireless signal of the device; and to connect to the first relay device; and, in parallel possibly simultaneously for recognising a second relay device for a second path or a second direction of a second wireless signal of the device; and to connect to the second relay device

According to an embodiment the device is to monitor an operation of a relay device described herein.

According to an embodiment the device is configured to: digitize a signals received from or transmitted to the relay device; and configured for monitoring possibly including logging an information such as a KPI and/or an event related to links to neighbouring nodes and or a further node one or more hops away.

According to an embodiment the device is configured for reporting a report based on the monitoring automatically or on demand.

According to an embodiment the device is configured for establishing a first connection to a first relay unit; and to discover a second relay unit that is connected to the same or another basestation; and to establish a second connection to the second relay unit to obtain an improved link to the basestation or a target device (e.g. a cloud service in the internet) when compared to the first connection; and to release the first connection.

According to an embodiment the first relay unit is formed by a first set of relay devices comprising at least one relay device; and wherein the second relay is formed by a second set of relay devices comprising at least one relay device

According to an embodiment the device is configured to signal a relaying capability information related to the device to a relay device connected with the device and/or to a basestation, e.g., to allow forwarding of the relaying capability information to the relay device.

According to an embodiment the device is configured to signalling a relay capability information that includes one or more of:
a relay node capability to UE, network and/or other relays, e.g., a concatenation of relays or meshing;
a supported relaying mode of the device, e.g., single hop, multi hop, supported number of connected devices such as UEs,
a supported processing time/tolerated latency;
a supported frequency band for relaying; and
information indicating a difference of a parameter between directions from a relay device to the network on the one hand and from the relay to a UE on the other hand.

When considering a network, the wireless communication network may be adapted for performing a relay candidate discovery, e.g. based on one or more of a proximity, location, reception/transmission range, reception conditions.

According to an embodiment, the wireless communication network is adapted for a detection of the relay device and a discovery procedure of the relay device based on the detection, the discovery procedure comprising one or more of:
reading out, e.g., receiving a capability signal, the capabilities of relays;
reading out, e.g., by receiving a signal from the device, a communication need of the device, e.g., a UE
reading out a list of connected relays/devices per Relay
calculating communication/relay routes to fulfil the communication needs, e.g., by
   considering a cost function
   performing a relay selection, e.g., per communication route
   performing a multi-hop path selection
   performing a resource assignment such as a resource pool, a slot structure, a relay role along a multi-hop trace
signalling the result to the Relays/UEs e.g., per path, i.e., a communication route or path segment

When referring to relay devices, e.g., in connection with the discovery phase, a relay device according to an embodiment may configured for signalling the capability information responsive to receiving a discovery message.

According to an embodiment the relay device is configured for including the capability information into a signal received from another device responsive to a discovery message received by the other device; wherein the relay device is adapted for forwarding the obtained signal within the wireless communication network.

According to an embodiment the relay device is configured for signalling a capability information of the relay device responsive to receiving a discovery message from another device in the wireless communication network, wherein the relay device is configured for skipping signalling the capability information based on a connection state of the relay device, e.g., having connectivity above or below a connectivity threshold.

### Relaying Procedure and Related Signalling (Connection Establishment)

Relaying procedure and related signalling include but are not limited to:
Resource assignment
   At UE to relay link (s=>ad hoc network), relay to relay links, relay to BS link (this may be identical to relay-relay link). The resources depend on the fact if we use the same or different frequency for the relay-to-relay link(s) and the relay to UE/BS link(s).
   Relaying frequencies reuse: Partial or full frequency reuse of adjacent relaying links or within a region of the relay links or a relay network can be supported.
Relaying network layout/topology discovery=>the detection part was described in the previous section. The procedure combines information of each relay, BS and UE in the network to build up a layout/routing topology of the network. In case of node mobility, the velocity of different participants needs to be taken into account. A further important aspect is the knowledge distributing about the network layout/topology within the network. This information can be shared entirely or in parts and within the entire network or in close proximity or the relay links. Means to distribute such information include for example broadcast, multicast, group cast or unicast message, which can be localized, e.g. in range or number of hops. Such knowledge distribution signalling can be performed by one, some or all devices involved in the relaying links, in close proximity or which become aware about the existence of relay links through reception of such messages. Furthermore, the distribution of such knowledge/information can be constraint, e.g. by limiting the addressee range to be within a certain device subgroup.
Routing assignment and announcement:
   Depending on the layout/topology, mesh can be supported as well:
      flooded mesh may be used (broadcast-based approach). The procedure should satisfy that the most far away relay in the right direction reports successful reception before doing an active relay forwarding.
      routed mesh may be used in single route or multi-route approaches. The use depends on the QoS requirements that shall be met. Routing setup procedure relies on the successful discovery of the relaying link options and their configuration.
Relay detection/identification procedure and signalling
Relay candidate identification and signalling:
   Blind: use a “ARP” process to find the target UE/closest BS, receive answers with possible routes (routes need a link qualification indicator (processing may be done by a gNB, so gNB eventually knows of all relays and can do a pre-processing of routes. Also gNB could create a digital twin of the relaying network
   Known Location: relays in the targeted direction towards destination
   Omniscient (for example due to gNB): already know the best candidates also with the least relaying workload:
      Relay location prediction.
      Relay Ownership based selection
Relay candidate selection and signalling:
   Candidate relay configuration
      Capability and feature exchange and matching with UE and gNB.
      Relay activation/deactivation (may also be enforced by the gNB)
UE configuration for transmission with relay
Communication between gNB and UE via relay
Communication between UE and UE via relay
Relay Synchronisation
   E.g. for wakeup to receive configuration information
Relay cluster configuration (Support for cooperative relaying concepts)

The related signalling includes but is not limited to:
Relay specific RS, beacons or pseudo-IDs to be shared between network entities including gNBs, UEs and/or relay(s)
   Maybe also a wakeup signal from the UE that forces sleeping relays to identify themselves
Network to UE/gNB signalling for configuration to detect and identify relays and their capabilities
Network to UE/gNB signalling on relay detection measurement procedure
   Measure and process, analyse, logging and reporting
Relay candidate negotiation between UE, gNB and relay (network controlled or directly driven by UE or coordinated by gNB)
Signalling to UE and relay to configure relay mode, (de)-activation/deactivation
Synchronization signal for ad hoc relaying networks that are not GPS synchronized (indoor)
Inter relay network communication signal, which may be different to a normal gNB UE link). Maybe more like IAB signal relaying.

Prediction signalling for moving relays (information on current location and estimated location in some seconds) to even allow a short-term usage of the moving relay (with fast moving relays a store and forward relaying may be done to the next gNB).

With reference to embodiments relating to a network, a wireless communication network according to an embodiment is configured for organising, on a network side, a relaying frequency reuse.

According to an embodiment, the wireless communication network is configured for combining information of each relay device, and end-devices of a link such as basestations and/or UEs, in the network; and for determining a layout topology or routing topology of the network.

According to an embodiment, the wireless communication network is configured for determining the layout topology or routing topology of the network based on a mobility of at least some of the relay device and/or the end-devices.

According to an embodiment, the wireless communication network is configured for distributing, at least in parts, the determined layout topology within the network.

According to an embodiment, the layout topology comprises a mesh-structure.

In order to enable a “routing instance” to make informed decisions, the remote and relay UEs can inform other parts of the network, e.g. other relays, UEs or the network (e.g. gNB, core network), about their current status or certain properties. These can be—in addition to the capabilities of the device (see section Relay node capabilities and associated capability signalling (initial setup))—measured data, performance levels, power saving states and others, e.g.:
Battery status
   Remaining battery level
   Battery temperature
   Performance class
   Current energy drain, e.g. in mA
   Ongoing charge procedure and parameters, e.g. current and voltage
Current Load
   Number of connected UEs, e.g. via Sidelink or non-3GPP wireless (or wired) connection.
      Number and/or list of Remote UEs
      Number and/or list of Relay UEs
   Uplink and downlink data rate, MCS
   HARQ status, e.g. number of Retransmissions, faulty packets, etc.
   Buffer status for up- and downlink
   CPU or processing load
   Load on specific encoding/decoding/support modules/chips, e.g. for audio/video processing or other specific algorithms
Priority
   Priority flag, could also be controlled by network
   Preferred applications
   Restrictions on the HOP-level in a multi-hop setup
Access Restrictions
   Block-lists of
      UEs
      Applications
      Traffic types
      Geo-Location
   Security requirements
      Minimum encryption levels/methods.
      List of supported encryption levels/methods
   Power Saving features of other UEs, if available
RSSI Readings
Mobility
   Current speed
   Current direction
   Stationarity

According to an embodiment, a relay device is provided that is configured for signalling a status information of the relay device to another device, the status information indicating a status of the relay device.

The status information comprises at least one of:
a battery status;
a load status;
a priority of traffic or applications providing the traffic;
access information relating to an access to a relay service;
access restriction information relating to a restriction of access to a relay service;
a reference signal received power, RSRP;
an received signal strength indicator, RSSI;
a parameter or flag recognised by the relay and indicating at least one of:
   a capability of further relays;
   a communication needs of a device using the relay device, e.g., a UE;
   a list of connected relays and/or devices per relay;
a mobility information indicating a mobility of the device.

### Path Discovery, Selection, and Construction

In at least some embodiments, path, branch and route mean basically the same thing a path is one possible connection between a source and a target/destination. A route is the same thing—one option out of multiple paths. A Branch as a single path, e.g. from the relay UE until the remote UE. Most of the time they are interchangeably but can be used specifically to point out variants in features.

The basic building procedure may comprise:
Discovery of relays candidates and/or path candidates
   Discovery of path segments
   Rating of path segments
      (ordering w.r.t. KPI/QoS; alternative path candidates)
   Selection of path segments
Path/Relay selection
   Based on QoS requirements or
   Based on preconfigured thresholds
Path construction
   Signalling
   Configuration
   Further signalling and configuration for next hop
E2E session establishment
   For one or multiple paths

There might be multiple possible paths or variations of an E2E connection path from a source UE to the base station or target UE. Instead of assigning for each transmission a list of path segments (including properties, source, target and other information) in every transmission, the source UE, target UR, relay UE or base station can assign ‘branch IDs’ or ‘path IDs’ to each of the paths that are discovered.

The relay nodes store the path or branch ID in order to send data via the associated branch. The branch ID can be indicated in the header of the data packet.

The source UE or the base station can decide on which branch or path to send a packet based on the properties of the branch or path or path segments, which can for example be:
QoS parameters
   Per HOP or for the whole branch (e.g. via average, min, max of single HOP QoS parameters)
   E2E link quality indication (QoS indication)
Latency
Jitter
HOP Count
Data rate limitations/estimates for up- and downlink
   Link-direction asymmetry, i.e. difference in up- and downlink KPIs, e.g. (direction-related assessment of link quality).
      SNR
      Data rate
      Modulation
      Interference.
Mobility (of involved UEs)
Throughput
A link metric used specifically for Sidelink
A link metric used for NTN communication
Measurement data available at the UEs
Headroom/margin w.r.t. throughput, latency TX or RX power, other QoS parameters

A device in accordance with this aspect, which is combinable with other embodiments without limitation, may be configured for wirelessly communicating in a wireless communication network, e.g., as a user equipment, UE, or a base station, the device configured for selecting at least a selected path segment of a path from a plurality of paths between the device as a source device and a sink device based on a property of the path; and transmitting a signal along the selected path.

According to an embodiment, the device is configured to include, into the signal, path information indicating the selected path or path segment to indicate at least a part of the path to a relay device relaying the signal towards the sink device.

According to an embodiment, the path information comprises a branch-ID indicating a branch or segment of the path between two hops of the path; or comprises a path ID indicating the path.

According to an embodiment, the device is configured is configured for selecting the path or path segment based on one of:
a quality requirement of the signal;
a level of quality, e.g., QoS provided by at least a part of the path or segment thereof;
a number of HOPs of the path or segment thereof;
a supported throughput in at least one direction of at least a part of the path;
a data rate supported by a node forming a node of the path;
a mobility of a node forming a node of the path;
a link metric associated with the path used specifically for Sidelink
a link metric used for non-terrestrial networks, NTN, communication
measurement data available at the device
a headroom/margin of a quality or control parameter.

According to an embodiment, the device is configured is configured for transmitting a discovery message to request information indicating at least a path or a path segment of the wireless communication network that is supported by a receiving node.

According to an embodiment, the device is configured is configured for recognising a relay device in the wireless communication network and for recognising a relay mode of the relay device according to which the relay device relays a wireless receive signal as a wireless transmit signal; wherein the device is configured for adapting a transmission of a wireless signal as the receive signal according to the relay mode; or adapting a reception of a wireless signal as the transmit signal according to the relay mode.

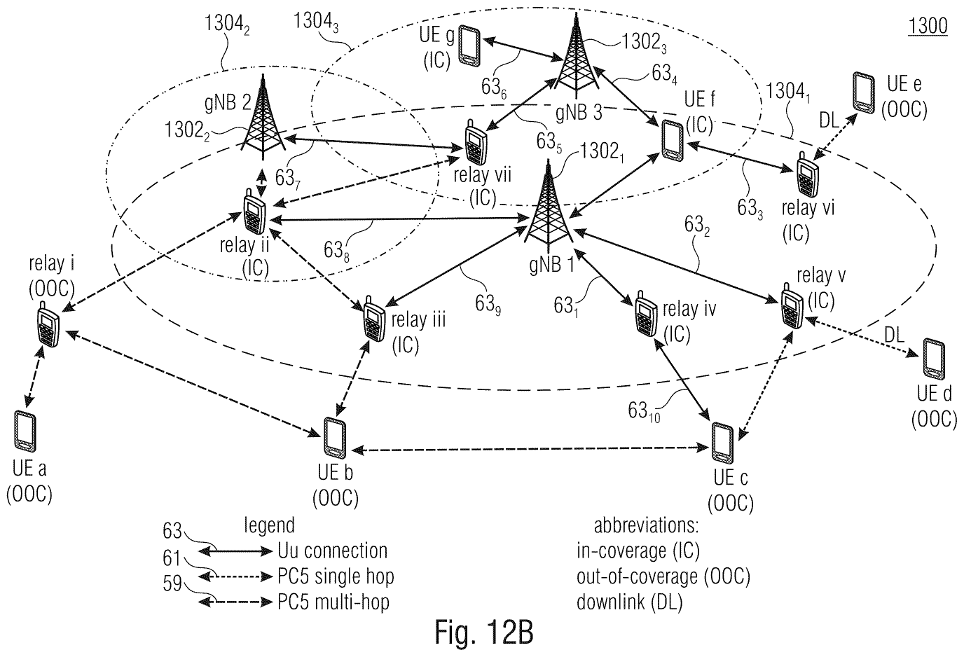

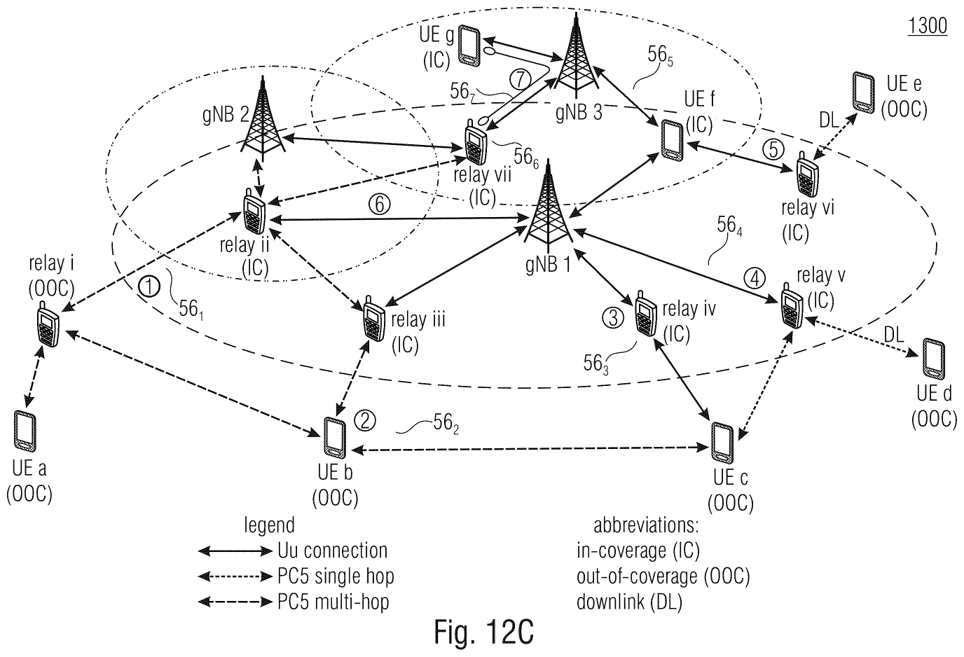

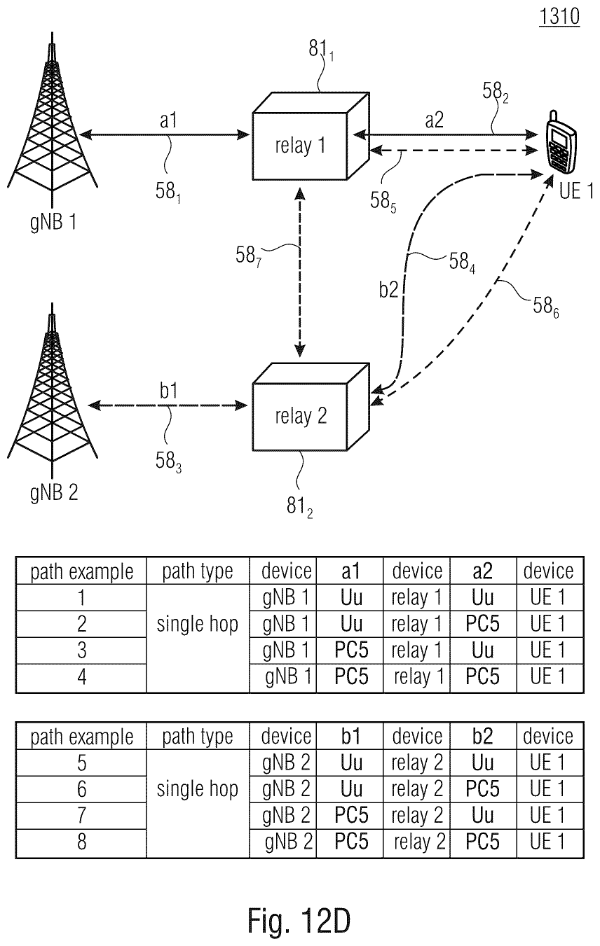

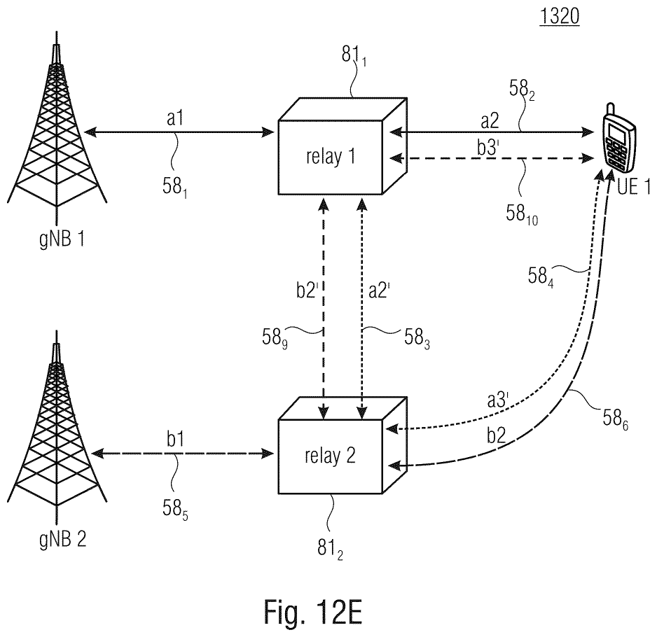

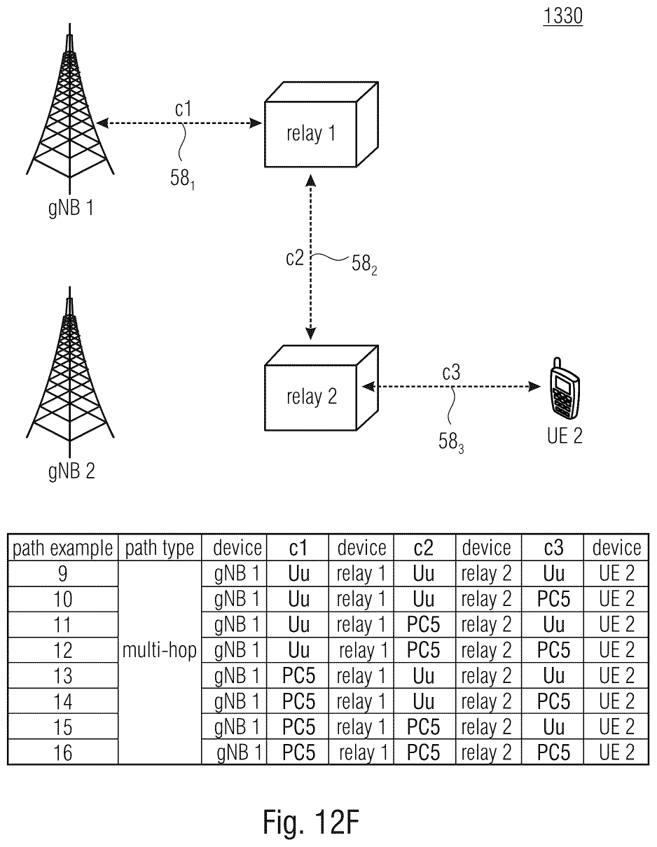

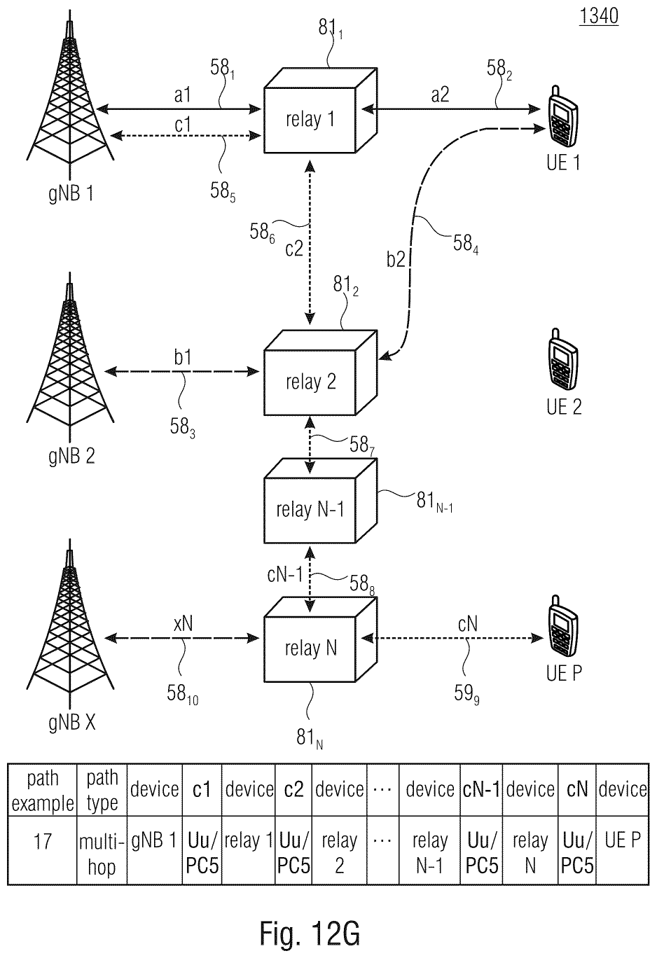

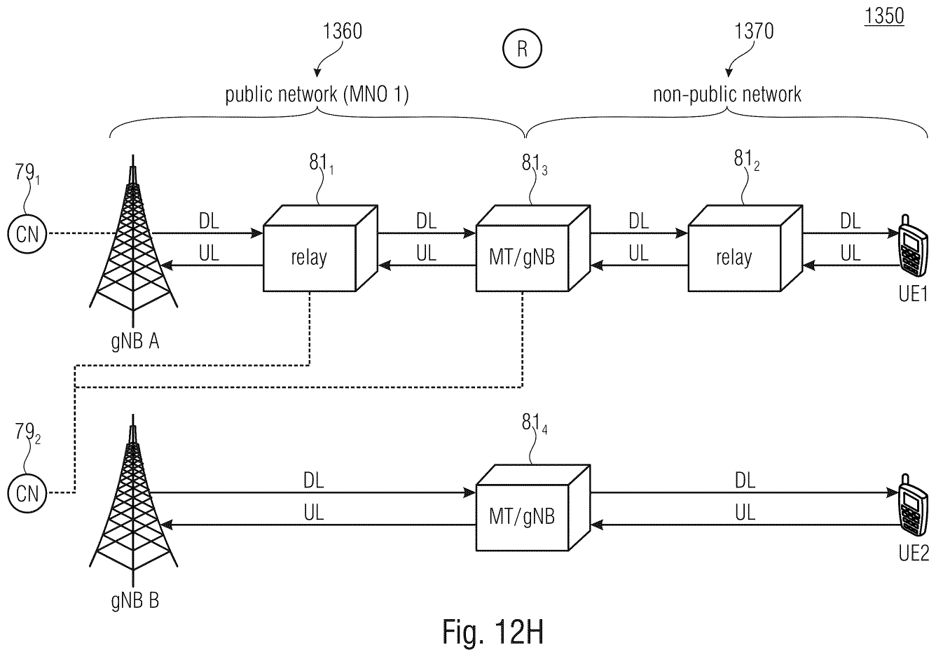

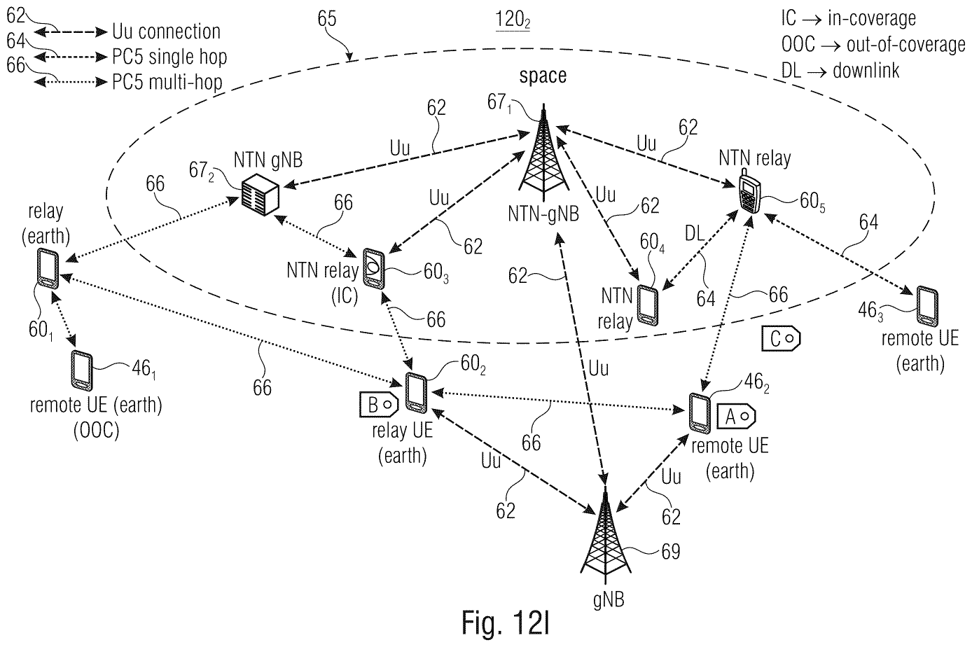

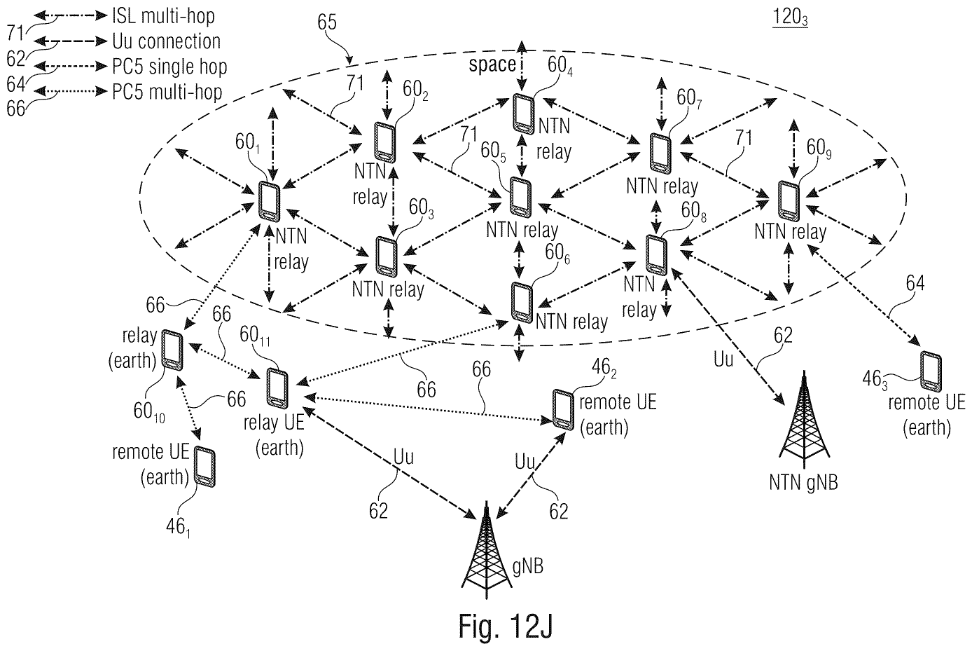

With reference to FIG. 12A showing a schematic block diagram of a wireless communication network 1201 according to an embodiment, there is shown the concept of different paths in a wireless communication network.

Different UEs as 461 to 468 are located in the wireless communication network 1201, some of the UEs being located within the coverage area 200, i.e., they may be in coverage, IC, and some of them outside thereof, i.e., out of coverage, OOC. UEs 461 to 468 may be operated, at least temporarily as a relay device described herein such as relay device 60, 70 and/or 80.

To different UEs such as remote UEs 461, 465 and 464 there may be provided paths 561, 562 and 563, each path having one or more path segments 58, wherein each path segment may be established by at least one of a Uu connection 62, a PC 5 single hop connection 64 or a hob of a PC 5 multi-hop 66. As may be seen, e.g. with regard to path 561 and 562, a UE such as UE 466 may be reached via different paths. It may therefore be of benefit when selecting at least a path segment towards a specific target, wherein such a selection may be implemented based on varying conditions such as varying positions, load scenarios, quality requirements or the like.

Embodiments, thus, relate to distributing information about links, paths or path segments within the network to a deciding entity, wherein such a deciding entity may be a central controller, may be located at a base station such as gNB 481, at a relay device, at a device being a source for a signal to be transmitted and/or a device being a sync of such a signal.

As may be seen from FIG. 12A, a device such as a relay device may operate a single path segment, see UE 461, may operate two path segments of a same or different paths, se UE 462 or UE 469 or may operate more than a single path and an increased number of path segments, see UE 466 or UE 464.

In other words, during the discovery phase a relay UE may answer discovery messages and include further information, alter, add or fuse (combine) path properties, beam IDs, frequency shifts, jitter, geolocation, relative location or distance. When sending the answer back the multi-hop chain, the same principle applies to the response message as for the discovery message. The gNodeB (base station) at the end then has a response with a branch ID and associated properties.

The path ID can be used by the remote UE to send the message on a specific path that matches the QoS requirements and/or supported feature set. The gNodeB can also use the path ID to schedule the downlink transmission back to the remote UE.

This way, the relay UEs do only need limited intelligence to do the routing, which only based on the discovery outcome and the resulting path ID/destination pairs.

### Procedure:

Remote UE A sends out discovery message. The discovery message is received by relay UE B, C and D. B and C send out a discovery message as well to find a path to the base station (if they don't already have a Uu connection/can establish a Uu connection). Relay UE D already has multiple uplink-heavy remote UEs to relay and does therefore not answer.

Finally two (or more) paths are established and the response message will go back the path until it reaches UE A that now has two relay/path candidates.

On another bearer for another service, the gNodeB is looking for UE A and tries to discover the UE via connected relay UEs. Relays B and C can reach UE A, but so can Relay D which is now answering the discovery, because there is downlink capacity. The gNodeB has the option to choose the ‘best’ connection out of three, whereas the remote UE only has two options.

Alternative routing options can be monitored but do not have to be active. They can be used as fallback in case of RLF on the other route. Also, conditional handover or re-configuration is possible in case the properties of one path do no longer meet the requirements.

With regard to the functionality of relaying described, e.g., in connection with relay devices, some of the described devices may receive a wireless signal, the wireless receive signal, and may actively form, generate and transmit a different wireless signal, the wireless transmit signal. Thus a different signal may be transmitted when compared to the received signal.

However, the same or a modified message, e.g., modified in view of time-to-live, hop-count, origin of the signal and the like, is contained in the wireless transmit signal when compared to the wireless receive signal such that the concept of relying a signal is not necessarily linked to transmitting the same signal although not excluding such an option. Embodiments referring to relaying of a signal thus relate to receiving the wireless receive signal and to transmit transmitting the wireless transmit signal based thereon and with a same or modified message contained therein.

Further advantageous embodiments with regard to the operation of relays and possibilities to make use thereof are described below.

FIG. 12B shows a schematic block diagram of a wireless communication network 1300 according to an embodiment. Wireless communication network 1300 may be a variation of wireless communication network 120₁ comprising several base stations 1302₁, 1302₂ and 1302₃ providing service in different coverage areas 1304₁, 1304₂ and 1304₃, respectively. Devices such as UEs within one or more coverage areas 1304₁, 1304₂ and 1304₃, respectively, are considered to be in-coverage, IC. Relay devices i through vii may be in accordance with a relay device described herein, i.e., a relay device according to an embodiment.

According to embodiments, a device maintaining a direct connection to a base station may use a Uu connection 63. A relay device relaying a wireless receive signal may use a single hop PC5 connection 61 or a PC5 multi-hop connection 59 for relaying. However, as shown, for example, for relay iv which may be a user equipment, UE or a different entity, may establish a Uu connection with a user equipment, e.g., UE c of the wireless communication network and for relaying the wireless receive signal to or from the user equipment UE c. Although using a Uu connection between relay iv and UE c may be used regardless whether UE c in-coverage or out-of-coverage, OOC, and regardless whether the signal is transmitted in uplink UL, or in downlink, DL, using a Uu connection 63₁₀ between relay iv and UE c may be of advantage when providing, at least in parts, a base station functionality for UE c by relay iv. For example, relay device iv may, in accordance with embodiments, provide at least a part of an access and mobility management function, AMF, and/or a location management function, LMF, for devices that are connected with the relay. Such a mechanism may be used, as an alternative or in addition, in a case where relay device iv misses a backhaul link. Alternatively or in addition, devices may benefit from such a mechanism when being operated as a receiver of the wireless transmit signal in a different network when compared to a source of the wireless receive signal.

In yet another advantageous modification, the relay device iv may use any 3GPP connection, or a non-3GPP connection such as a Bluetooth connection, a LiFi connection and/or a WIFI connection to connect to the gNB 1302₁ or UE c.

According to such an implementation, the relay device may maintain even two or more Uu connections to different devices, wherein one or more or even none of them may be a base station whilst the other is, for example, a UE or a different relay device. For example, relay i may, in some cases, decide to use Uu connections for UE a or UE b as well as for connecting to relay ii. This allows the relay device to establish two or more Uu connections and to maintain them simultaneously and for relaying wireless receive signals using two or more Uu connections.

In a different operation mode or in a different configuration/implementation a relay device according to an embodiment may be configured for receiving the wireless receive signal using a first PC5 connection established with a first device and for transmitting the wireless transmit signal, i.e., the relayed signal, using a second PC5 connection established with a second device, e.g., using a PC5 multi-hop connection 59.

The relay device according to an embodiment may establish the two or more PC5 connections with a relay device or a user equipment on the one hand and with a relay device or a user equipment at the other end. For example, the relay device may relay signals or messages between a user equipment and a relay device, between two relay devices or between two user equipment.

According to an embodiment, a relay device is provided that operates, at least in one relay mode, to simultaneously relay signals or messages in uplink and downlink. In yet another relay mode, a relay in accordance with an embodiment may be configured for simultaneously relaying signals or messages only in one of uplink and downlink, e.g., as part of a multi-TRP configuration. In such a multi-TRP configuration, different devices such as relays may commonly provide a downlink signal for a UE to avoid limitations due to blockage. In uplink for example, different relays may be used to provide for a high reliability of receiving signals. A wireless communication network according to an embodiment is configured for operating the plurality of relay devices in a multi transmission-reception-point, TRP, configuration for jointly receiving a signal or message from a device or for jointly transmitting a signal/message to the device.

In other words, FIG. 12B presents a simplified view of a mobile communications network comprised of base stations gNB 1, gNB 2 and gNB 3, user equipment terminals UE a-g and relays i-vii. Although the base stations may provide coverage to many UEs, for reasons of simplicity and visual clarity, the illustration shows only two UEs, i.e., UE f and UE g, as being in-coverage, IC, and 5 UEs UE a, UE b, UE c, UE d and UE e being out-of-coverage, OOC. As the network may include one or more relays, the coverage may be effectively extended so that communication links may be established between all UEs using one or more of the following types of connection: Uu, PC5 single-hop and PC5 multi-hop.

In connection with embodiments, reference is made to signals and to messages. For example, a signal may contain a message but may also be interpreted as a sort of message by itself, e.g., by its structure. For example, a Go-To-Sleep may be a signal, the same is true for Wake-Up(-Signals). In another example, paging in 3GPP is usually a message as well as configuration. In connection with embodiments, signal and message may be used as synonyms unless stated otherwise.

A device described herein, e.g., a UE making use of a relay, may be configured for selecting the selected path segment based on a report indicating a property such as capacity, load, throughput, of a link providing the path segment.

The same or a different device may be configured for establishing a Uu connection with the relay device.

The same or a different device may be provided with service by a first mobile network operator, MNO, wherein the relay device is provided with service by a second mobile network operator, MNO.

Relay devices described herein may incorporate one or more of the following functionality:

A relay device may be configured for establishing a Uu connection with a user equipment of the wireless communication network and for relaying the wireless receive signal to or from the user equipment.

For example, the Uu connection is a first Uu connection, the relay device being configured for establishing a second Uu connection with a further device such as a base station, a relay device or a user equipment, wherein the device is configured for relaying the wireless receive signal using the first and the second Uu connection.

A relay device may be configured for receiving the wireless receive signal using a first PC5 connection established with a first device and for transmitting the wireless transmit signal using a second PC5 connection established with a second device.

According to an embodiment, the first device is a relay device or a user equipment; and wherein the second device is a relay device or a user equipment.

According to an embodiment, in one of the relay modes the relay device is configured for simultaneously relaying signals in uplink and downlink.

According to an embodiment, in one of the relay modes the relay device is configured for simultaneously relaying signals only in one of uplink and downlink, e.g., as a part of a multi-TRP configuration.

A relay device may be configured for receiving, e.g., from a base station, a information indicating a configuration of resources of a sidelink; and from broadcasting, groupcasting or unicasting a resource pool configuration based on the information indicating a configuration of resources of a sidelink.

A relay device may be configured for monitoring a link property such as capacity, load, throughput, of a first link used for receiving the wireless receive signal or of a second link used for transmitting the wireless transmit signal and for providing a report indicating the property.

A relay device may be configured for receiving the wireless receive signal from a first wireless communication network and to transmit the wireless transmit signal to a different second wireless communication network;

According to an embodiment, the relay device implements a bridge between the first and second wireless communication network.

A relay device may be configured for receiving at least one of:
a relay wake up signal/message;
a go-to-sleep signal/message;
a paging signal/message; and
a configuration signal/message; and
for operating accordingly.

A relay device may be configured for transmitting at least one of:
a relay wake up signal/message;
a go-to-sleep signal/message;
a paging signal/message; and
a configuration signal/message.

A relay device may be a user equipment, UE, for operating in a wireless communication network and for at least temporarily operating as a relay device.

A relay device may be configured for using at least one of:
a Bluetooth connection;
a WiFi connection; and
a 3GPP connection
for receiving the wireless receive signal and/or for transmitting the wireless transmit signal.

According to an embodiment, the relay device is configured for providing at least a part of an access and mobility management function, AMF, and a location management function, LMF, for at least one device, e.g., in case of a missing backhaul link

Depending on the implementation of the satellite network, parts of the management functionality are located in the relay or base station instead of a core network, e.g. an AMF or location/positioning services. The AMF might be required to be executed locally to support routing of traffic, while location services benefit from lower latency.

FIG. 12C is identical to FIG. 12B with the exception that examples of paths 56₁ to 56₇ from base stations to user equipment devices are shown.

The following may be noted:
not all paths are shown in FIG. 12C but a selection of possible paths;
paths can provide either unidirectional or bidirectional connectivity; and
one or more paths can either originate or terminate at a base station or a UE.

FIG. 12C is illustrates the following path examples:
Path 56₁—from gNB 1 to Relay ii using a Uu connection; and from Relay ii to Relay i to UE a using a PC5 multi-hop connection. The path is fully bidirectional.
Path 56₂—from gNB 1 to Relay iii using a Uu connection; and from Relay iii to UE b to UE c using a PC5 multi-hop connection. UE b acts as a relay. The path is fully bidirectional.
Path 56₃—from gNB 1 to Relay iv using a Uu connection; and from Relay iv to UE c using a PC5 single-hop connection. The path is fully bidirectional.
Path 56₄—from gNB 1 to Relay v using a Uu connection; and from Relay v to UE d using a PC5 single-hop connection. From Relay v to UE d, the path is unidirectional providing downlink only.
Path 56₅—from gNB 3 to UE f to Relay vi using a Uu connection; and from Relay vi to UE e using a single hop connection. UE f acts as a relay. From Relay vi to UE e, the path is unidirectional providing downlink only.
Path 56₆—from gNB 3 to Relay vii using a Uu connection; from Relay vii to Relay ii to Relay iii to UE b using a PC5 multi-hop connection. The path is fully bidirectional.
Path 56₇—from gNB 2 to Relay vii to gNB 3 using a wireless connection such as a Uu/sidelink, e.g. to establish an Xn interface. The path is fully bidirectional. As an option the path could be extended to connect UE f to gNB 2 via the other entities.

According to an embodiment, one or more relays may be configured for receiving, e.g., from a base station, information indicating a configuration of resources of a sidelink. Such relay devices may be broadcast, groupcast or unicast a resource pool configuration based on the information indicating a configuration of resources of a sidelink. For example, relay vi being IC may receive a signal information block, SIB, and may forward this information via PC5 in broadcast, groupcast or unicast to OOC UE(s), e.g., UEE.

In some embodiments relay devices may also allow to overcome disconnectivity due to an operation of different devices by different mobile network operators. For example, and when referring to FIG. 12B and FIG. 12C, a UE being OOC may discover or see a relay. The UE is, for example, provided with service by a first mobile network operator and the relay device is provided with service by a different second MNO.

Nevertheless, the relay may accept relaying signals and the UE may be adapted to communicate with the relay. This may allow to support a UE that wants to connect to the network via a relay. Usually a relay will not answer the request since it does not belong to the same network/MNO. According to embodiments, this issue is addressed by relaying such signals. One possible part of such a solution is configuring a relay possibly being IC, to receive a system information, SIB, and/or a configuration for a sidelink, SL, pool and to broadcast/groupcast/unicast the resource pool information 21, a group of or all UEs around the relay, e.g., using a sidelink connection, PC5.

This may allow to implement a shared relay being shared between different MNOs.

FIG. 12D shows a simplified illustration that shows examples of single-hop connections between two different base stations gNB1 and gNB2, two different relays relay 1 labeled as relay 81₁ and relay 2 labeled as relay device 81₂ and a UE1. Relay device 1 and relay device 2 may be in accordance with an embodiment described herein.

FIG. 12D further shows eight path examples of a single hop connection between gNB 1 and UE 1 using relay 1, between gNB2 and UE 1 using relay 2 respectively. It may be seen that components 58₁ and 58₂ (A1 and A2) may be established as Uu connection or as PC5 connection each. Same is true for path segments 58₃ and 58₄.

A relay device in accordance with embodiments may also operate simultaneously, or time multiplexed in single-hop (solid lines of path segments 58₁, 58₂, 58₃ and 58₄) and/or in multi-hop mode forwarding the messages (dashed lines of path components 58₅, 58₆ or 58₇). Path component 58₇ may be assigned to gNB 1 or MNO 1 or assigned to gNB 2 or MNO 2.

UE can signal capability of supporting single-hop, multi-hop or combinations thereof. In accordance with embodiments,
Device (relay) may support:
   single-hop between
      a UE and a base station
      a UE and another UE
   multi-hop between
      a UE and another relaying device
      a UE and another UE
      another relaying device and further relaying device
      between a relaying device and a base station
   Uni-directional forwarding/relaying
   Bi-directional forwarding/relaying
   Routing capability on at least one of the forwarding links (device can route flows, traffic, packets, messages from one or multiple inputs to one or multiple outputs
   at least one forwarding mode, if multiple forwarding/relaying modes are supported, then:
      Device can be configured into one selected mode
      Device can be configured to switch between modes
      Device can be configured to operate multiple modes concurrently

Thus, the UE itself can support multi-hop as a UE-network, UE to NW, relay or a UE-UE/UE to relay.

FIG. 12E shows a simplified illustration of a wireless communication network 1320 deviating from wireless communication network 1310 of FIG. 12D and showing examples of both single-hop and multi-hop connections between two different base stations gNB1 and gNB2, two different relays relay 1 and relay 2 and UE1.

FIG. 12F shows a schematic block diagram of a wireless communication network 1330 comprising base stations gNB1 and gNB2 in accordance with embodiments, relay 1 and relay 2 being in accordance with embodiments and UE2 being in accordance with embodiments.

FIG. 12F further shows path examples 9-16 using different path components 58₁, 58₂ and 58₃ that may be associated with gNB1 or gNB2 each, the respective MNO, respectively.

In other words, FIG. 12F shows the potential multihop relaying path from gNB1 via Relay1 and Relay2 to UE2 and vice versa. The type of the actual interconnection link or path segment 58₁ between gNB and Relay1, 58₂ between Relay1 and Relay 2, and 58₃ between Relay 2 and UE can be of a different type as shown in the table of FIG. 12F. In this example the currently known and supported interfaces are Uu and PC5 but also future interfaces may be considered. It is shown that each link is able to support interfaces independent of each other. This also means that the capabilities of the links may be different resulting in a potential different setup/deployment of an overall scenario. Potentially depending on the usecase a dynamic switching between the different interfaces may be possible and can result from the movement dynamics of the individual entities in the network.

FIG. 12G shows a simplified illustration of a wireless communication network 1340 according to an embodiment having base stations gNB1, gNB2, . . . , gNBX, several relay devices relay 1, relay 2, relay M−1, relay N and UEs UE1, UE₂ and UEP in accordance with embodiments. Further, a path example 17 is shown indicting that by way of a multi-hop connection different devices up to UE P may be reached whilst each of the respective path components 58₁ to 58₁₀ may be established and/or maintained as a Uu connection or a PC5 connection or a different connection, e.g., a Bluetooth connection or a WIFI connection or a different 3GPP connection.

In other words, the illustration in FIG. 12G shows an example of a combination of single- and multi-hop connections between the UEs and corresponding gNBs. A single-hop connection is established, for example, using path components 58₁ and 58₂, 58₃ and 58₄ respectively. In particular, the data to UE1 can be transmitted from all the gNBs 1,2 and X by using the interfaces between the Relays 2, N−1 and N. To simplify the forwarding it may be beneficial to use same communication protocol in the whole forwarded path. This requires the exchange of capability information in the partial network. In a mixed protocol scenario e.g. PC5, Uu, Bluetooth etc., the relays would have to decode and then forward the information.

Also the network advantageously monitors the link capacity/load (e.g., a resource utilization, a CPU load, . . . ) in order to allow efficient forwarding of messages, e.g., by path selection, throughout the complete routing path.

FIG. 12H shows a schematic block of at least a part of a wireless communication scenario 1350 comprising a first wireless communication network 1360, e.g., a public network operated by MNO1, and a further wireless communication network 1370 being, for example, a different public network or non-public network.

Each of networks 1360 and 1370 may comprise a dedicated core network, CN, 79₁, 79₂, respectively.

Relay devices 81₃ and 81₄ may form a bridge between networks 1360 and 1370. Alternatively or in addition, the relay device 81₃ and 81₄ may be configured for providing at least a part of an access and mobility management function, AMF, and/or location management function, LMF, for one or more devices, e.g., for relay 81₂, UE1, UE₂, respectively. For example, such operation may be provided for UE1, UE₂ and/or relay 81₂, e.g., if they lack a separate or dedicated backhaul link.

Relay 81₁ may be controlled, for example, by core network 79₁ and/or 79₂. Alternatively or in addition, relay device 81₃ may be controlled by core network 79₁ and/or 79₂. Those relay devices may, thus, form a shared relay device.

A wireless receive signal received by relay device 81₃ or 81₄ from a first wireless communication network 1360 or 1370 may be transmitted to the other wireless communication network as the wireless transmit signal. Thereby, the relay device may implement a bridge between the wireless communication networks 1360 and 1370.

One or more of the relay devices 81₁ to 81₄ may be operated as so-called enhanced relay devices. For example, such devices may receive signals that are not only dedicated for relaying on a point-to-point manner.

For example, with reference to FIG. 12H the relay 81₃ and/or 81₄ (R) can be considered as a network separator or bridge. Two core networks 79₁ and 79₂ (CNs) are shown.

A relay 81₁ top 81₄ in may be a separate entity or combined with a mobile termination, MT, and/or a base station, gNB to form a device capable of relaying traffic.

For example, the MT/gNB block 84₄ in FIG. 12H in the lower part may be a combination of a UE and a base station, providing RAN access to UE 2. UE 1 can also access the lower CN 79₂ via a connection of the MT/gNB node 81₃ and an optional relay 81₂.

The top CN 79₁ and the bottom CN 79₂ of FIG. 12H are different CNs, i.e., not the same, and can be operated as full core networks or as virtual core networks within another core network providing flexibility to MNOs and non-public-network, NPN, providers.

While the CN 79₁ may manage the public network 1360, the core network 79₂ may manage the NPN network 1370. For the NPN part to be able to work properly, the CN 79₂ may be needed to be available for the MT/gNB device 81₃. Therefore two main options exist for the MT/gNB device:
Connection to the CN 79₂ via the MT or Relay 81₃ connected to the CN 79₁; and/or
Hosting CN 79₂ within the NPN 1370, e.g. at the MT/gNB 81₃ device without requiring the CN 79₁ to operate.

Shown is an example scenario with a relay device providing bridging capabilities between MNO1 and non-public network (NPN), e.g. a cruise ship or a factory. In these scenarios the NPN can host its on CN or CN can be forwarded through the MT/gNB.

The first network may form a “backhaul” or “anchor” path to (R) (the relay or bridge). Furthermore, the operation of the relay can comprise
Forwarding in one direction only, e.g. DL can be received at the UE1 but the UL needs to be relayed due to UL pathloss constraints.
Bidirectional Forwarding, i.e. both UL and DL directions.

An enhanced Relay node, may support functionalities like sending/receiving
a relay wake up signal/message (from UE, BS, other relays, . . . to potential relays (sending such a signal may wake up others, e.g., from a discontinuous reception mode, DRX))
a go to sleep signal/message
a paging signal/message
a configuration signal/message

The second network (NW) can be a different public network or a non-public NW, a private NW or a campus NW that uses Uu, sidelink, or other connections such as Bluetooth, Wi-Fi or Li-Fi connections. The relay device may use such connection for communication.

The configuration of the second network may be done by one or more of the following:
First network's CN 79₁
Second network's CN 79₂
Autonomously by gNB in the second network 1370

The routing from gNB A to UE 1 may be either:
Fully-transparent to one or both ends of the communication link; or.
Partially-transparent as far as the relay (R).

A device such as a UE described herein may be configured for recognising the relay device based on at least one of information indicating a configuration of resources of a sidelink or a resource pool configuration.

FIG. 12I shows a schematic block diagram of a wireless communication network 120₂ according to an embodiment. FIG. 12I shows a possible realization of a relay network that comprises both ground segments and space segments. Furthermore, this illustrates space-borne gNBs connected to UEs on the ground via NTN relays. For example, relays devices 60₁ and 60₂ may be configured for relaying signals along paths as described in connection with FIG. 12A. Relay devices 60₁ and/or 60₂ may be located on earth implemented as stationary devices or mobile devices, e.g., a UE 46 of FIG. 12A. Each relay device 60 of wireless communication network 120₂ may be adapted as relay 70 and/or 80.

Relay devices 60₃, 60₄ and 60₅ may be located in space 65, e.g., being part of a satellite, a space station or a space ship. The wireless communication network 120₂ may comprise one or more spaceborne base stations such as NTN gNBs 67₁ and 67₂ that may communicate with each other, e.g., using Uu connections 62 and/or communication with a base station, gNB, 69, e.g., a base station of wireless communication network 100, for example, using a Uu connection 62. Relays 60₃ to 60₅ may utilise PC5 connections, e.g., as a multi-hop connection or a single-hop connection. Relays 60₃ to 60₅ may provide service for one or more UEs 46₁ to 46₃, e.g., using a PC5 connection to assist a terrestrial base station 69 or a spaceborne base station 67 with providing service by providing additional connections or data streams or by providing a substitute, e.g., for UEs that are OOC.

FIG. 12J shows a schematic block diagram of a wireless communication network 120₃ according to an embodiment. FIG. 12J shows a possible realization of a relay network that comprises both ground segments and space segments as described in connection with FIG. 12I. In wireless communication network 120₃ space-borne relay devices 60₁ to 60₉ may be connected to UEs and gNBs on the ground, e.g., using a PC5 connection and/or a Uu connection 62. Space-borne relay devices 60₁ to 60₉ may communicate with each other and with other devices vie inter satellite links, ISL, 71. Moreover, ground-based UEs 46₁ to 46₃ may connect to gNBs of a terrestrial network via relays of the ground and/or—as shown for remote UE 46₃—via a relay device of the space segment. In each of the wireless communication networks, there is provided a solution for relaying signals between devices, such as UEs and/or base stations, wherein the relaying connection may comprise one or more hops and may be located on the ground, on earth respectively, may be operated partially as a TN and partially as a NTN or may be operated completely as an NTN, e.g., relaying signals between spaceborne devices.

### Distributed HARQ

HARQ may be done with increased granularity when compared to for a complete path, up to on every HOP if sufficient data is already available and re-transmission can be done on a per-HOP basis instead of E2E. Of multi-path is used in combination with multi-hop there is also the possibility that a ‘distributed HARQ’ can be performed by having multiple versions of the same data via multiple paths.

If the same content of the PDCP packet arrives via multiple MAC packets, an ID may be used to mark the PDCP packet in the MAC packets. For example, PDCP Duplication may be used.

The invention offers the following benefits:
Reduced latency
Increased data rate
Improved reliability
Range extension
Resilient routing
Coverage infill
Concealed routing—less vulnerable to intrusion/attacks
Support of network coding
Energy saving—distributed nodes activation/deactivation
Interference management
Lower packet jitter on higher layers
Enables multi-operator (aggregation) shared relay nodes.
Multi-access conversion (TDD-FDD, Frequency range, FRa←→FRb)

Relay devices described herein further relate, in some embodiments, to a relay device, configured for receiving the wireless receive signal and/or for transmitting the wireless transmit signal as an optical/photonic signal, e.g. laser beam, free-space optics, infrared (IR), visible light communication (VLC) or a radio frequency signal, e.g. HF, VHF, UHF, micro-wave, millimetre-wave, (sub-) THz.

According to an embodiment, the relay device is configured for relaying the wireless receive signal as a first wireless receive signal along a first path of a wireless communication network; and configured for relaying a second wireless receive signal along a different second path of the same or a different wireless communication network, the first path and the second path maintained simultaneously or sequentially.

According to an embodiment, the relay device is configured for relaying signals along the first path in a first operation mode and for relaying signals along the second path in a different second operation mode.

According to an embodiment, the relay device is configured for providing a retransmission of the wireless transmit signal on a HOP basis, e.g., based on a HARQ procedure. As a HOP one may understand a relaying device or entity that transmits or retransmits a signal to provide for a further source of a signal and a further reception of a signal.

According to an embodiment, the relay device is configured for relaying the wireless receive signal along different paths or path segments in the wireless communication network.

According to an embodiment, the relay device is configured for selecting at least one selected path from a plurality of paths between the relay device and a sink device or a further relay device based on a property of the path; and transmitting a signal along the selected path; or configured for selecting at least one selected path segment from a plurality of path segments between the relay device and a sink device or a further relay device based on a property of the path segment; and transmitting a signal along the selected path segment. For example, beyond a single selected path there may be selected a further route to be used in parallel or as a fallback option.

According to an embodiment, the relay device is configured to select the selected path or path segment based on a decision of the relay device or based on a decision received from a deciding entity. A device requiring relay services may, according to an embodiment, be adapted in a same manner.

Embodiments further relate to aspects of a wireless communication network. According to an embodiment, a wireless communication network comprises at least one relay device described herein.

According to an embodiment, the wireless communication network comprises a plurality of relay devices configured for jointly relaying a signal in the wireless communication network via a plurality of hops.

According to an embodiment, the wireless communication network comprises a plurality of relay devices configured for jointly relaying a signal via alternative routes in the wireless communication network.

According to an embodiment, the wireless communication network is configured for relaying a signal between a first device and a second device via the relay device; wherein the wireless communication network is configured to adapt an operation of the first device, the second device and/or the relay device according to the respective capability of another device.

According to an embodiment, the wireless communication network is adapted for a detection or identification of the relay device as a relay candidate of a set of relay candidate devices for a future relaying of a signal, the detection being based one or more of:
a blind detection
a known location of the relay device
an omniscient detection

According to an embodiment, based on the detection, the wireless communication network, e.g., a relay control entity, is configured for selecting a relay device from the set of relay candidate devices for a use of the relay device in at least one route of the wireless communication network; and to configure the selected relay candidate devices accordingly.

According to an embodiment, based on the detection, the wireless communication network, e.g., a relay control entity, is configured for activating and/or deactivating at least one relay device.

According to an embodiment, based on the detection, the wireless communication network, e.g., a relay control entity, is configured for configuring at least one relay device.

According to an embodiment, based on the detection, the wireless communication network, e.g., a relay control entity, is configured for synchronising a set of relay devices of the wireless communication network.

According to an embodiment, based on the detection, the wireless communication network, e.g., a relay control entity, is configured for clustering a set of relay devices of the wireless communication network.

According to an embodiment, to operate the at least one relay device, the wireless communication network is adapted for a signalling at least one of:
relay specific RS, beacons or pseudo-IDs to be shared between network entities including gNBs, UEs and/or at least one relay;
a wakeup signal from the UE that forces sleeping relays to identify themselves;
network to UE/gNB signalling for configuration to detect and identify relays and their capabilities;
network to UE/gNB signalling on relay detection measurement procedure;
   Measure and process, analyse, logging and reporting;
relay candidate negotiation between UE, gNB and relay (network controlled or directly driven by UE or coordinated by gNB);
signalling to UE and relay to configure relay mode, (de)-activation/deactivation;
synchronization signal for ad-hoc relaying networks that are, e.g., not GPS synchronized such as indoor;
inter relay network communication signal, which may be different to a normal gNB UE link, e.g., similar to IAB signal relaying; and
prediction signalling for moving relays (information on current location and estimated location in some seconds) to even allow a short-term usage of the moving relay (with fast moving relays a store and forward relaying may be done to the next gNB).

According to an embodiment, the wireless communication network is adapted to transmit a discovery message to a relay device and to receive a capability information responsive to the discovery message to obtain information about a capability of the relay device and/or about an identifier identifying at least a segment of a path provided by the relay device

According to an embodiment, the wireless communication network, e.g., a source device or a base station is configured for controlling different relays along a same path or path segment to provide for a multi-hop relaying.

According to an embodiment, the wireless communication network is adapted to control the relay devices into a same or different relay modes.

According to an embodiment, the wireless communication network is adapted to control the relay devices based on a relay capability of the relay devices.

According to an embodiment, the wireless communication network comprises a path using radio frequency, RF, link and/or a path using a cable-less media, e.g., for transmitting optical signals.

In an embodiment, a computer readable digital storage medium has stored therein a computer program having a program code for performing, when running on a computer, a method described herein.

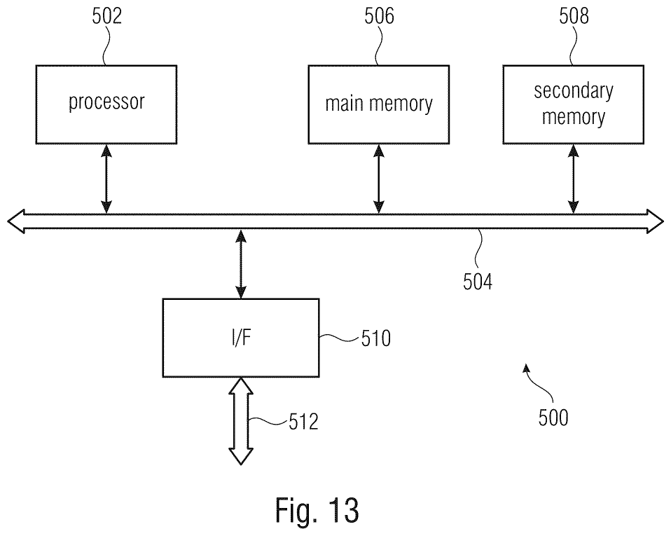

Various elements and features of the present invention may be implemented in hardware using analogue and/or digital circuits, in software, through the execution of instructions by one or more general purpose or special-purpose processors, or as a combination of hardware and software. For example, embodiments of the present invention may be implemented in the environment of a computer system or another processing system. FIG. 13 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form of electronic, electromagnetic, optical, or other signals capable of being handled by a communications interface. The communication may use a wire or a cable, fibre optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

| | | Further |
|---|---|---|
| Abbreviation | Definition | description |
| 2G | second generation | |
| 3G | third generation | |
| 3GPP | third generation partnership project | |
| 3PC | third-party controller | |
| 4G | fourth generation | |
| 5G | fifth generation | |
| 5GC | 5G core network | |
| AAS | active antenna system | |
| AAU | advanced antenna unit | |
| ACLR | adjacent channel leakage ratio | |
| ADC | analogue-to-digital converter | |
| AF | application function | |
| AP | access point | |
| ARQ | automatic repeat request | |
| AU | antenna unit | |
| BER | bit-error rate | |
| BLER | block-error rate | |
| BP | behaviour plane | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal strength | |
| CP | control plane | |
| CP1 | control plane 1 | |
| CP2 | control plane 2 | |
| CPRI | common public radio interface | |
| CSI | channel state information | |
| CSI-IM | CSI interference measurement | |
| CSI-RS | CSI reference signal | |
| CU | central/centralized unit | |
| D2D | device-to-device | |
| DAPS | dual active protocol stack | |
| DAC | digital-to-analogue converter | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DT | digital twin | |
| DU | distributed unit | |
| ECGI | e-UTRAN cell global identifier | |
| E-CID | enhanced cell ID | |
| eCPRI | enhanced CPRI | |
| eNB | evolved Node b | |
| EN-DC | e-UTRAN-New Radio dual connectivity | |
| EUTRA | enhanced UTRA | |
| E-UTRAN | enhanced UTRA network | |
| FSS | frequency-selective surface | |
| gNB | next generation NodeB | |
| GNSS | global navigation satellite system | |
| GPS | global positioning system | |
| GSO | geostationary orbit | |
| HAPS | high-altitude platforms | |
| HARQ | hybrid ARQ | |
| IAB | integrated access and backhaul | |
| ID | identity/identification | |
| IF | intermediate frequency | |
| IIOT | industrial internet of things | |
| KPI | key-performance indicator | |
| LTE | long-term evolution | |
| MCG | master cell group | |
| MCS | modulation coding scheme | |
| MDT | minimization of drive tests | |
| MIB | message information block | |
| MIMO | multiple-input/multiple-output | |
| MLR | measure, log and report | |
| MLRD | MLR device | |
| MNO | mobile network operator | |
| MR-DC | multi-rat dual connectivity | |
| NCGI | new radio cell global identifier | |
| NEF | network exposure function | |
| NG | next generation | |
| ng-eNB | next generation eNB | node providing |
| | | E-UTRA user |
| | | plane and control |
| | | plane protocol |
| | | terminations |
| | | towards the |
| | | UE, and connected |
| | | via the NG |
| | | interface |
| | | to the 5GC |
| NG-RAN | either a gNB or an NG-eNB | |
| NGSO | non-geostationary orbit | |
| NIC | network interface connection | |
| NR | new radio | |
| NR-U | NR unlicensed | NR operating |
| | | in unlicensed |
| | | frequency |
| | | spectrum |
| NTN | non-terrestrial network | |
| NZP-CSI-RS | non-zero-power CSI-RS | |
| OAM | operation and maintenance | |
| OEM | original equipment manufacturer | |
| OTT | over-the-top | |
| oRAN | see open RAN | |
| Open RAN | open radio access network | |
| PCI | physical cell identifier | Also known |
| | | as PCID |
| PDCP | packet data convergence protocol | |
| PDCCH | physical downlink control channel | |
| PDSCH | physical downlink shared channel | |
| PER | packet error rate | |
| PHY | physical | |
| PLMN | public land mobile network | |
| PRACH | physical random access channel | |
| PUCCH | physical uplink control channel | |
| PUSCH | physical uplink shared channel | |
| PSBCH | physical sidelink broadcast channel | |
| PSCCH | physical sidelink control channel | |
| PSSCH | physical sidelink shared channel | |
| PSFCH | physical sidelink feedback channel | |
| QCL | quasi colocation | |
| RA | random access | |
| RACH | random access channel | |
| RAN | radio access network | |
| RAT | radio access technology | |
| RF | radio frequency | |
| RIM | radio access network information management | |
| RIM-RS | rim reference signal | |
| RIS | reconfigurable intelligent surface | |
| RISC | RIS controller | |
| RLC | radio link control | |
| RLF | radio link failure | |
| RLM | radio link monitoring | |
| RP | reception point | |
| R-PLMN | registered public land mobile network | |
| RRC | radio resource control | |
| RRU | remote radio unit | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| RU | radio unit | |
| SA | standalone | |
| SCEF | service capability exposure function | |
| SCG | secondary cell group | |
| SDU | service data unit | |
| SIE | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SRI | srs resource indicator | |
| SS | synchronization signal | |
| SSB | synchronization signal block | |
| SSID | service set identifier | |
| SS-PBCH | sounding signal/physical broadcast channel | |
| TAC | tracking area code | |
| TB | transmission block | |
| TCI | transmission configuration indication | |
| TDD | time division duplex | |
| TN | terrestrial network | |
| TRD | transmit/receive device | |
| TRP | transmission reference point | |
| TSG | technical specification group | |
| UAV | unmanned airborne vehicle | |
| UE | user equipment | |
| UL | uplink | |
| UP | user plane | |
| URLLC | ultra-reliable low latency communication | |
| UTRAN | universal trunked radio access network | |
| V2X | vehicle-to-everything | |
| VoIP | voice over internet protocol | |
| vRAN | virtual ran | |
| WI | work item | |
| WLAN | wireless local area network | |
| ZP-CSI-RS | zero-power CSI-RS | |

1. A relay device configured for relaying a wireless receive signal as a wireless transmit signal;
wherein the relay device is configured for a plurality of relay modes; and is adapted for changing an operation of the relay device to at least one of the plurality of relay modes responsive to a control signal.

2. The relay device of claim 1, wherein the plurality of relay modes comprises at least a subset of:
an amplify and forward mode;
a band switch amplify and forward mode;
a decode and forward mode;
a store and forward mode.
band switch decode and forward
band switch store and forward

3. The relay device of claim 1, wherein in a first relay mode and in a second relay mode, the relay device is adapted for implementing different modes of:
a U2U relay mode, where the relay device relays between a first UE and a second UE,
a U2N relay mode, where the relay device relays between a UE and a network node,
a relay mode, where the relay device relays between a UE and a relay device,
a relay mode, where the relay device relays between a first relay device and a second relay device, and
a relay mode, where the relay device relays between a relay device and a network node.

4. The relay device of claim 1, wherein the relay device is adapted to operate in a wireless communication network; and is configured for receiving the control signal from a user equipment of the wireless communication network.

5. The relay device according to claim 1, comprising an antenna unit and an actuator; wherein the actuator is configured for changing an orientation of the antenna unit to change a direction and/or polarisation of a signal received or transmitted with the antenna unit with reference to a further device.

6. The relay device according to claim 1, wherein the relay device is implemented as a UE, a gNB, an RU, a DU, a CU, an IAB-node such as an IAB-DU or an IAB-MT), a repeater, a relay-node, a RIS or any other node or device which supports reception and transmission of wireless signals.

7. The relay device according to claim 1, wherein the relay device is configured for receiving a request for relaying a signal from a first device such as a user equipment, UE, or another relay device to a second device such as a basestation or another relay device;
wherein the relay device is configured to negotiate a parameter of a first connection between the relay device and the first device with the first device; and/or
configured to negotiate a parameter of a second connection between the relay device and the second device with the second device to establish at least a part of a relayed connection between the first device and the second device.

8. The relay device according to claim 1, wherein the relay device is configured for receiving a connection information from the wireless communication network, e.g., a deciding entity thereof, the connection information indicating a parameter of a connection of the relay device to another device; wherein the relay device is configured for controlling the connection based on the connection information.

9. The relay device according to claim 1, wherein the relay device is configured for signalling to the wireless communication network a configurability information indicating that the relay device will operate according to a connection information received from the wireless communication network that indicates a requested parameter of a connection of the relay device; and/or indicating that the relay device will forward connection information to a device indicated in the connection information.

10. The relay device according to claim 1, wherein the relay device is configured for signalling a capability information of the relay device to another device, e.g., a gNB, the capability information comprising:
a physical layer parameter like frequency ranges, carrier bandwidth, possible transmission parameters,
a capability to support multi-hop,
a number of supported hops,
a number of supported simultaneous UEs,
a position or location in a multi-hop route, e.g., a geolocation, and/or a relative location or distance
an orientation, a polarization, an polarization match, a directivity of receive or transmit beampattern for the 1^{st} or 2^{nd} link of the relay
an implemented or supported TDD frame structure,
a supported relay mode,
a multi-path support such as
a direct and at least one indirect path to the other device; or
at least two indirect paths to the other device;
wherein an Indirect path is a non-3GPP path or a 3GPP path not based on Sidelink:
a path property or path-segment property
a beam ID,
a frequency shift, and
a jitter.

11. The relay device according to claim 1, wherein the relay device is configured for receiving a wireless receive signal to be relayed through a unidirectional or a bidirectional path segment; and/or
wherein the relay device is configured for transmitting a wireless transmit signal relaying a receive signal through a unidirectional or a bidirectional path segment.

12. The relay device according to claim 1, wherein the relay device is to operate a path segment of a path between a base station and a user equipment, UE, based on a selection related to an associated parameter that relates to at least one of a quality of service, a priority, a redundancy, and a latency of a relayed signal.

13. The relay device according to claim 1, wherein the relay device is configured for signalling a status information of the relay device to another device, the status information indicating a status of the relay device.

14. The relay device according to claim 1, configured for receiving the wireless receive signal and/or for transmitting the wireless transmit signal as an optical/photonic signal, e.g. laser beam, free-space optics, infrared, visible light communication or a radio frequency signal, e.g. HF, VHF, UHF, micro-wave, millimeter-wave, (sub-) THz.

15. The relay device according to claim 1, wherein the relay device is configured for providing a retransmission of the wireless transmit signal on a HOP basis, e.g., based on a HARQ procedure.

16. The relay device according to claim 1, configured for receiving the wireless receive signal using a PC5 connection established with a first device and for transmitting the wireless transmit signal using a Uu connection established with a second device; and/or configured for receiving the wireless receive signal using the Uu connection established with the second device and for transmitting the wireless transmit signal using the PC5 connection established with the first device.

17. The relay device according to claim 1, configured for receiving the wireless receive signal using a first PCS connection established with a first device and for transmitting the wireless transmit signal using a second PC5 connection established with a second device.

18. The relay device according to claim 17, wherein the first device is a relay device or a user equipment or a base station; and wherein the second device is a relay device or a user equipment or a base station.

19. The relay device according to claim 1, wherein in one of the relay modes the relay device is configured for simultaneously relaying signals in uplink and downlink.

20. The relay device according to claim 1, wherein in one of the relay modes the relay device is configured for simultaneously relaying signals only in one of uplink and downlink, e.g., as a part of a multi-TRP configuration.

21. The relay device according to claim 1, configured for receiving, e.g., from a base station a information indicating a configuration of resources of a sidelink; and from broadcasting groupcasting or unicasting a resource pool configuration based on the information indicating a configuration of resources of a sidelink.

22. The relay device according to claim 1, configured for monitoring a link property of a first link used for receiving the wireless receive signal or of a second link used for transmitting the wireless transmit signal and for providing a report indicating the property.

23. The relay device according to claim 1, configured for receiving at least one of:
a relay wake up message/signal;
a go-to-sleep message/signal;
a paging message/signal; and
a configuration message/signal; and
for operating accordingly.

24. The relay device according to claim 1, configured for transmitting at least one of:
a relay wake up message/signal;
a go-to-sleep message/signal;
a paging message/signal; and
a configuration message/signal.

25. The relay device according to claim 1, being a user equipment, UE, for operating in a wireless communication network and for at least temporarily operating as a relay device.
